(19) United States
(12) Patent Application Publication
(10) Pub. No.: US 2009/0037523 A1
(43) Pub. Date: Feb. 5, 2009

(54) System and Method for Synchronizing an Offline Web-Based Application with an Online Web-Based Application

(76) Inventors: Daniel J. Kolke, North Bend, WA (US); Ahmad Baitalmal, Renton, WA (US); Jon K. Collette, Normandy Park, WA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/102,848

(22) Filed: Apr. 14, 2008

Related U.S. Application Data
(60) Provisional application No. 60/962,877, filed on Jul. 31, 2007.

(51) Int. Cl. G06F 15/16

(52) U.S. Cl. 709/203

(57) ABSTRACT

A system and a method for executing a web-based application on a client computer system without a network connection to an application server that hosts the web-based application is presented. In these embodiments, the web-based application can provide functionality substantially similar to the functionality of the web-based application when the client computer system has a network connection to the application server. A system and method for synchronizing and resolving conflicts between an online and an offline web-based application is also presented.

### RELATED APPLICATIONS

This application is related to U.S. patent application Ser. No. ______, “SYSTEM AND METHOD FOR RUNNING A WEB-BASED APPLICATION WHILE OFFLINE” filed on the same date as this application, (Attorney Docket Number 069904-5001), which application is incorporated by reference herein in its entirety.

This application is also related to U.S. patent application Ser. No. ______, “SYSTEM AND METHOD FOR RESOLVING CONFLICTS BETWEEN AN OFFLINE WEB-BASED APPLICATION AND AN ONLINE WEB-BASED APPLICATION” filed on the same date as this application, (Attorney Docket Number 069904-5603), which application is incorporated by reference herein in its entirety.

### TECHNICAL FIELD

The disclosed embodiments relate generally to systems and methods for synchronizing an offline web-based application with an online web-based application.

### BACKGROUND

The number and types of web-based applications is increasing. Some web-based applications have developed to the point where they have become essential to day-to-day business transactions. For example, online customer relationship management (CRM) tools allow sales representatives the ability to access client contact information from anywhere in the world where an Internet connection is available. These web-based applications are typically hosted on application servers which can be access through a network connection such as the Internet. Unfortunately, network connections may not always be reliable and access to a web-based application may be lost at an inopportune time. Furthermore, users may be in areas where there are not network connections available (e.g., on a plane, etc.). Once the Internet connection is lost, some or all functionality provided by the web-based application may be lost. For example, the online CRM may no longer be able to provide data for contacts because the data is located on the application server, which is no longer available to the user.

### SUMMARY

Some embodiments of the present invention are directed to a system and a method for executing a web-based application on a client computer system without a network connection to an application server that hosts the web-based application. In these embodiments, the web-based application can provide functionality substantially similar to the functionality of the web-based application when the client computer system has a network connection to the application server.

Some embodiments of the present invention are directed to a system and a method for providing on a computer system a local software stack configured to provide local web services for dynamic, web-based applications that are executed on the computer system when it is offline. When the computer system is offline, the computer system executes a dynamic, web-based application using the web services provided by the local software stack, such that functionality of the dynamic, web-based application when the computer system is offline is substantially similar to functionality of the dynamic, web-based application when the computer system is online.

Some embodiments of the present invention are directed to a system and a method for making changes to a web-based application while the first computer system is does not have a network connection to an application server and tracking the changes made to the web-based application while the first computer system is disconnected from the application server In these embodiments, the web-based application is not designed to be used while a first computer system on which the web-based application executes does not have a network connection to an application server. When the network connection between the first computer system and the application server is reestablished, the changes for the web-based application made on the first computer system are synchronized with the web-based application on the application server. The changes for the web-based application made on the application server are also synchronized with the web-based application on the first computer system.

Some embodiments of the present invention are directed to a system and a method for using a web-based application on the first computer system while the first computer system is disconnected from an application server. In response to detecting a network connection to the application server, changes for a web-based application made on a first computer system are synchronized with a web-based application on an application server. Changes for the web-based application made on the application server are also synchronized with the web-based application on the first computer system. In these embodiments.

Some embodiments of the present invention are directed to a system and a method for using a web-based application that is configured to interact over a network connection with an application server to provide specified functionality on a first computer system that is disconnected from the application server. When the network connection is reestablished, changes made to the web-based application while the first computer system was disconnected from the application server are synchronized. If a conflict between the first computer system and the application server exists, the conflict is resolved so that both the first computer system and the application server are synchronized with each other.

Some embodiments of the present invention are directed to a system and a method for creating a first set of records with a corresponding first set of identifiers in a first database and synchronizing the first database with a second database. If the corresponding first set of identifiers already exists in the second database, a new set of identifiers for the first set of records is received from the second database, wherein the new set of identifiers is assigned to the first set of records when the first set of records is added to the second database. All references to the corresponding first set of identifiers for the first set of records are updated with the new set of identifiers for the first set of records.

Some embodiments of the present invention are directed to a system and a method for using a dynamic, web-based application configured to interact over a network connection with an application server to provide desired functionality, disconnecting the network connection from the application server, and continuing to use the web-based application while still providing the desired functionality.

### BRIEF DESCRIPTION OF THE DRAWINGS

FIG. 1 presents a block diagram of a network, according to embodiments of the present invention.

FIG. 2 presents a block diagram of a network, according to embodiments of the present invention.

FIG. 3 presents a block diagram of an application database, according to embodiments of the present invention.

FIG. 4 presents a block diagram of a user database, according to embodiments of the present invention.

FIG. 5 presents a block diagram of a synchronization engine on an application server, according to embodiments of the present invention.

FIG. 6 presents a block diagram of a synchronization engine on a client computer system, according to embodiments of the present invention.

FIG. 7 presents a block diagram of an application server, according to embodiments of the present invention.

FIG. 8 presents a block diagram of a client, according to embodiments of the present invention.

FIG. 9 presents a block diagram illustrating exemplary group memberships for users for a given web-based application, according to embodiments of the present invention.

FIG. 10 presents a block diagram of an exemplary AOP framework which provides offline access to a web-based application, according to embodiments of the present invention.

FIG. 11 illustrates an exemplary process of using an AOP framework to run a web-based application while offline, according to embodiments of the present invention.

FIG. 12 presents a block diagram of an exemplary process of installing an instance of an AOP framework on a client computer system, according to embodiments of the present invention.

FIG. 13 illustrates an exemplary process of installing an instance of an AOP framework on a client computer system, according to embodiments of the present invention.

FIG. 14 presents a block diagram of an exemplary process of initializing an AOP account on a client computer system, according to embodiments of the present invention.

FIG. 15 illustrates an exemplary process of initializing an AOP account on a client computer system, according to embodiments of the present invention.

FIG. 16 presents a block diagram of an exemplary process of installing a web-based application on a client computer system, according to embodiments of the present invention.

FIG. 17 illustrates an exemplary process of installing a web-based application on a client computer system, according to embodiments of the present invention.

FIG. 18 presents a block diagram of an exemplary process of performing an initial data synchronization for a web-based application on a client computer system, according to embodiments of the present invention.

FIG. 19 illustrates an exemplary process of performing an initial data synchronization for a web-based application on a client computer system, according to embodiments of the present invention.

FIG. 20 presents a block diagram of an exemplary process of using the AOP framework on a client computer system, according to embodiments of the present invention.

FIG. 21 illustrates an exemplary process of using the AOP framework on a client computer system, according to embodiments of the present invention.

FIG. 22 presents a block diagram of an exemplary process for a client computer system determining how to access a web-based application, according to embodiments of the present invention.

FIG. 23 illustrates an exemplary process for a client computer system determining how to access a web-based application, according to embodiments of the present invention.

FIG. 24 presents a block diagram of an exemplary process for synchronizing a web-based application on a client computer system with a web-based application on an application server, according to embodiments of the present invention.

FIG. 25 illustrates an exemplary process for synchronizing a web-based application on a client computer system with a web-based application on an application server, according to embodiments of the present invention.

FIG. 26 presents a block diagram of an exemplary process for synchronizing a web-based application on a client computer system with a web-based application on an application server, according to embodiments of the present invention.

FIG. 27A illustrates an exemplary process for synchronizing a web-based application on a client computer system with a web-based application on an application server, according to embodiments of the present invention.

FIG. 27B continues the process illustrated in FIG. 27A, according to embodiments of the present invention.

FIG. 27C continues the process illustrated in FIG. 27B, according to embodiments of the present invention.

FIG. 27D continues the process illustrated in FIG. 27C, according to embodiments of the present invention.

FIG. 27E continues the process illustrated in FIG. 27D, according to embodiments of the present invention.

FIG. 27F continues the process illustrated in FIG. 27E, according to embodiments of the present invention.

FIG. 28 presents a block diagram of an exemplary process for resolving conflicts for web-based applications that use auto-incrementing identifiers, according to embodiments of the present invention.

FIG. 29 illustrates an exemplary process for resolving conflicts for web-based applications that use auto-incrementing identifiers, according to embodiments of the present invention.

FIG. 30 presents a flowchart of an exemplary process for providing access to a web-based application while offline, according to embodiments of the present invention.

FIG. 31 presents a flowchart of an exemplary process for synchronizing a web-based application on a client computer system with a web-based application on an application server, according to embodiments of the present invention.

FIG. 32 presents a flowchart of an exemplary process for synchronizing a web-based application on a client computer system with a web-based application on an application server, according to embodiments of the present invention.

FIG. 33 presents a flowchart of an exemplary process for resolving conflicts between a web-based application on a client computer system and a web-based application on an application server, according to embodiments of the present invention.

FIG. 34 presents a flowchart of an exemplary process for resolving conflicts between a web-based application on a client computer system and a web-based application on an application server which use automatically incrementing identifiers for database records, according to embodiments of the present invention.

FIG. 35 presents a flowchart of an exemplary process for providing access to a web-based application while offline, according to embodiments of the present invention.

FIG. 36 presents a block diagram illustrating an exemplary user interface for creating synchronization rules, according to embodiments of the present invention.

FIG. 37 presents a block diagram illustrating an exemplary user interface for generating auto-incrementing identifiers, according to embodiments of the present invention.

FIG. 38 presents a block diagram illustrating an exemplary process for creating synchronization rules, according to embodiments of the present invention.

FIG. 39 presents a flowchart of an exemplary process for creating synchronization rules, according to embodiments of the present invention.

FIG. 40 presents a block diagram of an exemplary foreign key mapping, according to embodiments of the present invention.

FIG. 41 presents a flowchart of an exemplary process for creating a foreign key mapping, according to embodiments of the present invention.

Like reference numerals refer to corresponding parts throughout the drawings.

### DESCRIPTION OF EMBODIMENTS

### Definitions

A Remote Procedure Call (RPC) is a programming interface that allows one program to use the services of another program in a remote machine. The calling program sends a message and data to the remote program, which is executed, and results are passed back to the calling program. Note that RPC refers to XML RPC.

A virtual host (vhost) is a server that contains multiple web sites, each with its own domain name. A <virtualhost> . . . . </virtualhost>is an Apache HTTP server directive (instruction) that maps domain names to different directories (and other instructions) on the filesystem. vhosts can be used to define the boundaries of an application. Each web-based application in an account on the client computer system must have at least one virtual host in Apache. Note that there can be more than one vhost, all pointing to the same shared directory/config. Also note that other web servers have similar functions as the Apache virtualhost directive.

Vmap is a virtual database query map. A vmap is a variable map, or a field map. It maps variables (columns, fields) in one database to variables (columns, fields) in another DB.

LAMP is a solution stack of software that is used to run dynamic web sites. The LAMP solution stack typically comprises open source software. The LAMP stack can refer to a suite of software which includes LINUX, Apache HTTP server, MySQL and/or PostgreSQL, Perl, Python, Ruby, Ruby on Rails, Apache Tomcat, and/or PHP.

A solution stack is a set of software subsystems or components that are required to deliver a specified solution (e.g., product or service).

A web application or a web-based application is an application that can be accessed through the web over a network (e.g., the Internet, etc.). Web-based applications typically generate dynamic content. Dynamic content is content that can be generated when a request is received from a user. For example, a user may request scores for one or more sporting events. These scores can be retrieved and a page listing the scores can be displayed to the user. Alternatively, dynamic content can be periodically generated and cached. When a user requests the dynamic content, the cached version is displayed to the user. Web-based applications do not require distribution because they are typically hosted on an application server. Users who desire to use a web-based application can use a browser to access the application server hosting the web-based application. A client-server model requires a specialized client program which serves as a user interface to the server and which must be installed on each computer system that is to access the server application. Any upgrades to the server application typically require an update to the client application. In contrast, web-based applications use a browser engine, such as found in a web browser engine, as an interface to the application server. In general, each page delivered to the browser is a static document; however, the static document is typically composed of a number of dynamic elements that arc embedded into the document prior to being delivered to the browser. Web-based applications are typically structured as a three-tier application with a browser engine at the first tier, an engine that can process dynamic content (e.g., scripting languages, etc.) in the second tier, and a database in the third tier.

### Overview

Presently, in order to receive the full functionality of a web-based application, the client computer system must be able to communicate with an application server hosting the web-based application. Although some features of a web-based application may be available while the client computer system is not connected to an application server hosting the web-based application, other features of the application server may not function properly or may not function at all if the client computer system is not connected to the application server. For example, consider a user who wants to update a contact in a web-based address book. Updating a contact in a web-based address book typically requires updating data records in a database or some other mechanism for storing and managing data (e.g., files). Typically, the database is part of the application server or accessible to the application server through a network connection. Thus, in order to update a contact in the web-based address book, the client computer system for the user must be connected to the application server hosting the web-based address book so that the update to the contact can be made to in the database.

Thus, in some embodiments, a client computer system is loaded with a framework that allows the client computer system to access web-based applications locally without requiring a network connection to an application server hosting the web-based application. This framework is referred to as the “Applications on a Plane” (AOP) framework in this specification. This framework is useful for at least traveling salespeople, drivers, business travelers (e.g., on airplanes), etc. In these embodiments, while working on the application locally, data can be added, modified, and changed without the need to be connected to the application server hosting the web-based application. The AOP framework tracks the changes and when the network connection between the client computer system and the application server is reestablished, the changes can be synchronized between the client computer system and the application server.

In some embodiments, the AOP framework can include an application server and an account management system. In some embodiments, the application server is the Etelos Application Server (EAS). In some embodiments, the account management system is the Etelos Management System (EMS). This specification may use the terms EAS and EMS in the generic sense to refer to an application server and an account management system, respectively.

In some embodiments, AOP framework installations can be split into two steps: installation of an open source stack (e.g., Apache HTTP server, PHP, PostgreSQL, MySQL, Python, etc.) and installation of the AOP framework (e.g., the EAS and EMS installation). Other software stacks can be used. For example, WAMP (Windows, Apache HTTP server, MySQL, PHP) and/or LAPP (Linux, Apache HTTP server, PostgreSQL, PHP).

In some embodiments, AOP synchronization is managed at two levels. A user-based synchronization enables the user to synchronize information that only the user is allowed to see based upon a set of user-based synchronization rules. A group administrative synchronization synchronizes all changes in the web-based application for a user that a user is allowed to see because of group administrative permissions.

In some embodiments, the AOP framework allows existing web-based applications to support offline use on a client computer system (e.g., without a connection to an application server that hosts the web-based application) without changing the architecture and code for the web-based application. For example, if a developer builds a web-based application based on the Linux, Apache HTTP server, MySQL, and PHP (LAMP) web development environment, the web-based application can be used in the AOP framework with little or no code changes. A developer can then use an administrative tool to create rules for how the web-based application is to be synchronized with client computer systems that have made changes to the web-based application while offline. Note that in prior art systems, a developer must re-architect (e.g., changing the data model) and/or recode the web-based application to be able to run on a client computer system without a network connection to an application server.

In some embodiments, the AOP framework assigns a local domain extension to a universal resource locator (URL) for a web-based application so that a user can access the web-based application on the client computer system instead of on the application server. In doing so, a user can choose when to access the web-based application locally and when to access the web-based application on the application server. For example, the local domain extension can be an “.aop” suffix which is added to the end of the URL. If the URL is http://appl.com, the modified URL is http://appl.com.aop. If a user wants to run the web-based application on the AOP framework on a client computer system, the user can access the web-based application by entering the local URL (e.g., http://appl.com.aop). Note that the “.aop” suffix is one example of a suffix that can be appended to a URL. Any other suffix can be appended to a URL. Alternatively, the URL can be modified in other ways (e.g., completely rewriting the URL, etc.) that can indicate local access is required. In some embodiments, an entry in a hosts file is added to map the URL with the appended suffix to the local client computer system. In other embodiments, an entry in a domain naming service is added to map the URL with the appended suffix to the local client computer system.

In some embodiments, a suffix is not appended to the URL. In these embodiments, the URL itself is used to direct the browser to the local web server on the client computer system. In these embodiments, an entry in the hosts file or in a DNS server on the client computer system associates the URL with the client computer system. Note that since a client computer system starts its search for an IP address associated with the URL on the client computer system, if an IP address is found in the hosts file or a local DNS server on the client computer system, the client computer system uses this IP address regardless as to whether or not another IP address (e.g., the real IP address exists).

Allowing users to make changes to web-based applications while disconnected from an application server hosting the web-based application creates several problems including synchronization of data between the client computer system and the application server. As long as the client computer system is connected to the application server, the two systems can remain synchronized with each other by periodically communicating with each other (e.g., through polling or through triggers). However, offline use of web-based applications can cause data conflicts because users can be creating, modifying, and deleting records on different instances of the web-based application. This problem is compounded by the fact that most web-based applications use automatically incrementing database identifiers to provide a unique identifier for a given database record. For example, for a user table, the user ID column may use an automatically incrementing user ID generator. When a new user is added to the user table, the database determines the next unique user ID from the automatically incrementing user ID generator. Since, each instance of the web-based application includes the automatically incrementing user ID generator which increments the next user ID independently of the other instances of the web-based application, it is possible that the user IDs between all of the instances of the web-based application are not unique. Thus, in some embodiments, the AOP framework provides a synchronization technique which can solve the above-described problems. The synchronization technique can be separate from the web-based application so that the code for the web-based application does not need to be modified. Not modifying the code is advantageous for at least the reason that rearchitecting and recoding web-based applications can be a burdensome and time-consuming process.

Most applications that are designed for the web are designed to run on a single large piece of infrastructure with shared resources. This technique allows a “software as a service” (SaaS) provider to scale the infrastructure as needed. Since many users (e.g., companies) may be using the same database separated only by differences in primary keys, control to applications and databases are set so that security is not compromised. These security models arc difficult to port to existing systems that allow use of web-based applications while disconnected from an application server. However, the AOP framework solves these problems as described below. In some embodiments, the AOP framework enables users to see only their own data and not see data from other users. However, if a user is a part of an administrative group, the administrative user can see data for other users over which the administrative user has administrative rights.

In some embodiments, the AOP platform provides mechanisms for distribution of web-based applications through a marketplace. These mechanism can facilitate billing services (e.g., for purchases, subscriptions, and other licenses) and user management.

### AOP

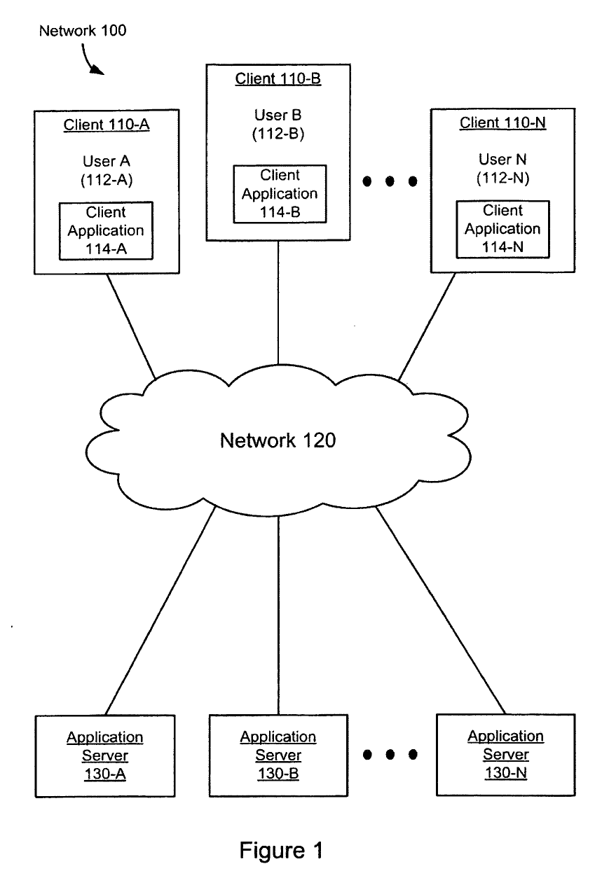

FIG. 1 presents a block diagram of network 100, according to embodiments of the present invention. Network 100 includes clients 1 10-A to 110-N and application servers 130-A to 130-N. Clients 110-A to clients 110-N and application servers 130-A to 130-N are connected to each other through network 120. Network 120 can include, but is not limited to, a local area network (LAN), a wide area network (WAN), the Internet, an intranet, a wireless network, a mobile network, a combination of networks, or any type of network now known or later developed. Clients 110-A to 110-N can not only communicate with application servers 130-A to 130-N through network 120, but can also communicate with each other through network 120. Similarly, application servers 130-A to 130-N can communicate with each other through network 120.

In some embodiments, application servers 130-A to 130-N include one or more web-based applications. In some embodiments, a web-based application is an application that is hosted on an application server and that can be accessed by clients that are connected to the application server through a network. Although a web-based application may have a set of functionality that can be used without a network connection to the application server hosting the web-based application, a web-based application typically has another set of functionality that cannot be used by a client computer system unless the client computer system is connected to the application server hosting the web-based application. For example, the set of functionality that requires a network connection to the application server can include functionality that requires access to data stored in a database for the web-based application.

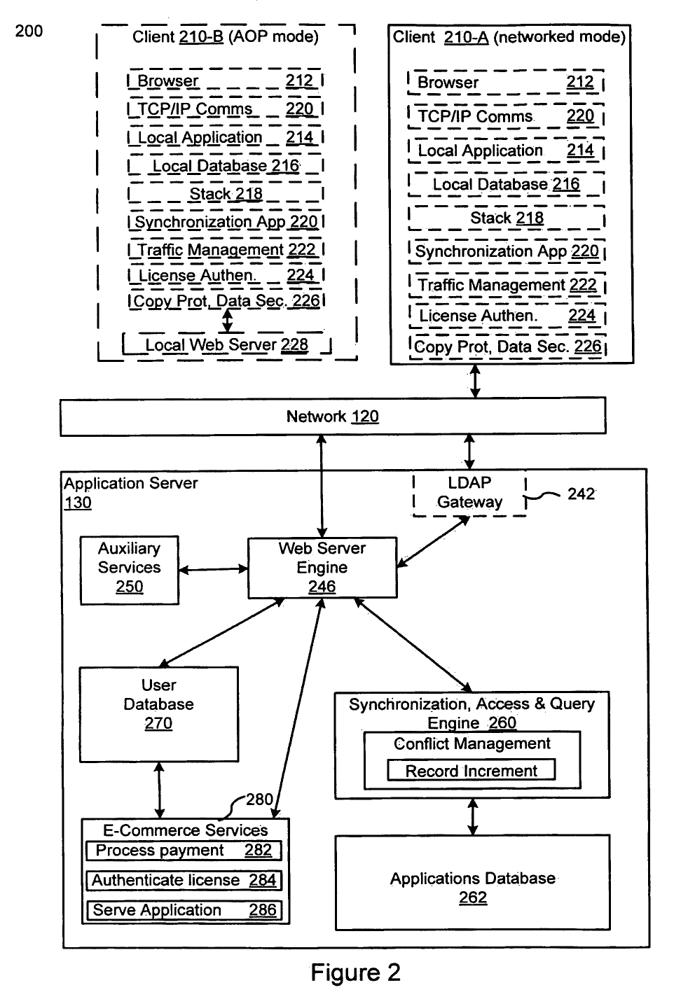

FIG. 2 presents a block diagram of network 200, according to embodiments of the present invention. Network 200 includes clients 210-A and 210-B, network 120, and application server 130. Clients 210-A and 210-B may correspond to any one of clients 110-A to 110-N illustrated in FIG. 1. Application server 130 may correspond to any one of the application servers 130-A to 130-N illustrated in FIG. 1.

Clients 210-A and 210-B include browser 212, TCP/IP communications module 220, local application 214, local database 216, stack 218, synchronization application 220, traffic management module 222, license authentication module 224, copy protection and data security module 226. Browser 212 can include any application that can access data and/or services on a remote computer system through a network (e.g., network 120). In some embodiments, browser 212 is a web browser. TCP/IP communications module 220 provides procedures and routines that allow clients 210-A and 210-B to communicate with other computer system through network 120 using the TCP/IP protocol.

Local application 214 can include any application that can be run on a client. In some embodiments, local application 214 is an instance of a web-based application that is hosted on an application server (e.g., application server 130).

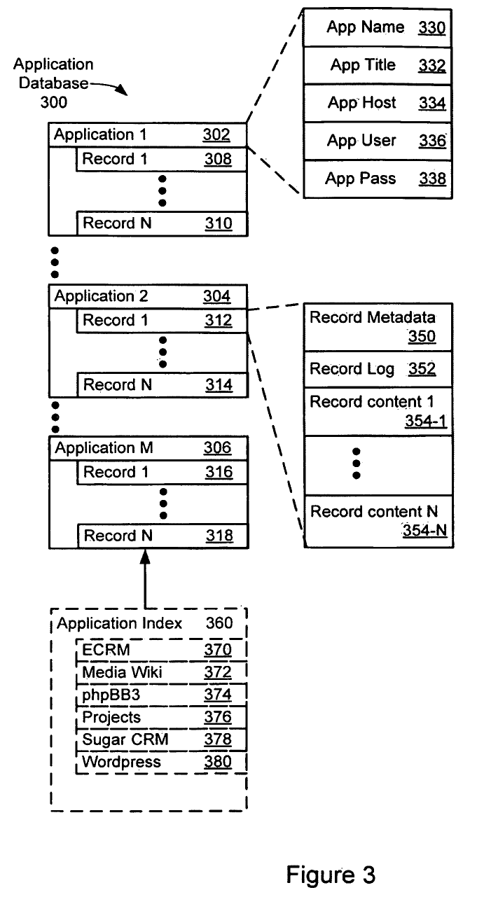

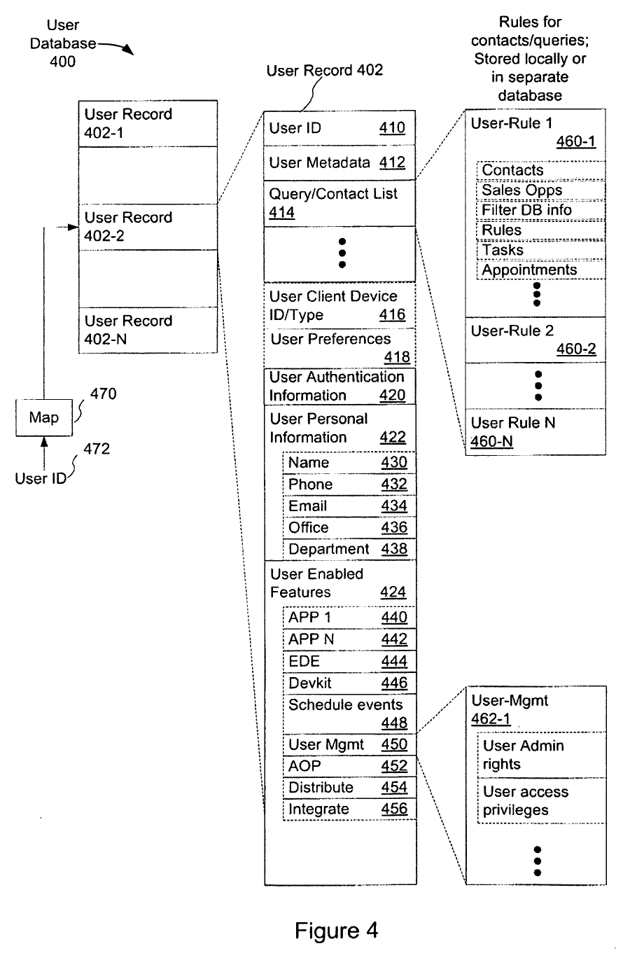

Local database 216 can include a database that can be used by local application 214. For example, local database 216 can include, but is not limited to, MySQL, PostgreSQL, ORACLE, etc. In some embodiments, local database 216 includes a user database and an application database. The user database is described in more detail below with reference to FIG. 4. The application database is described in more detail below with reference to FIG. 3.

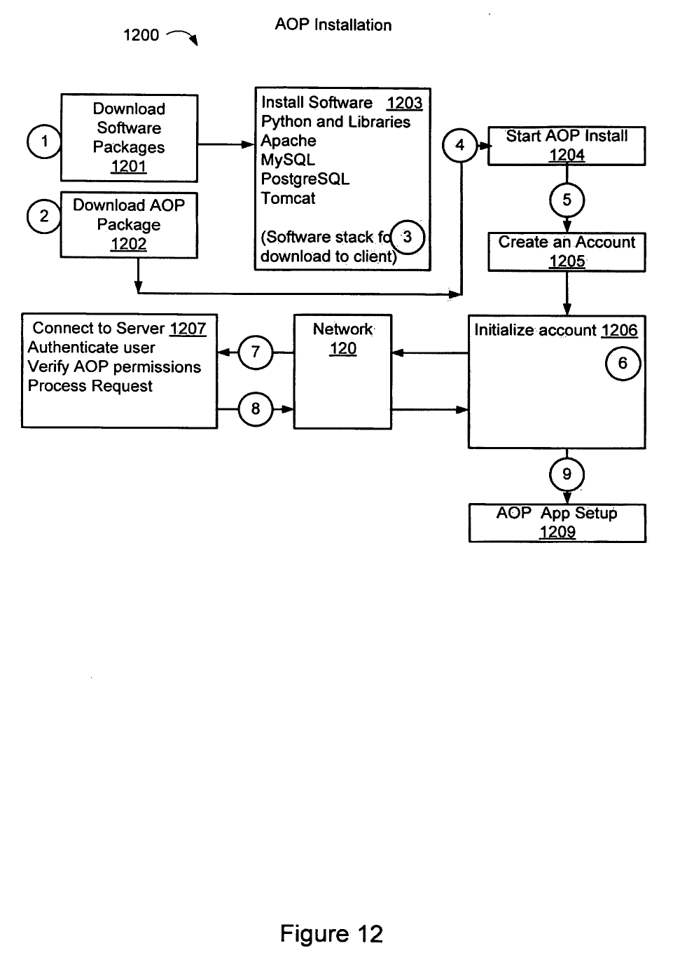

Stack 218 can include a number of software packages that enable a web-based application to run on a client. In some embodiments, the software packages can include, but are not limited to, a web server (e.g., Apache HTTP Server), a database (e.g., MySQL, PostgreSQL, ORACLE), application servers (e.g., Apache Tomcat), scripting languages (e.g., Python, Ruby, Ruby on Rails, etc.), and libraries. In some embodiments, stack 218 includes open source software (OSS) packages. In some embodiments, the OSS packages include Apache HTTP server, MySQL, PostgreSQL, Apache Tomcat, Python, and libraries. Stack 218 is described in more detail below with reference to FIG. 12.

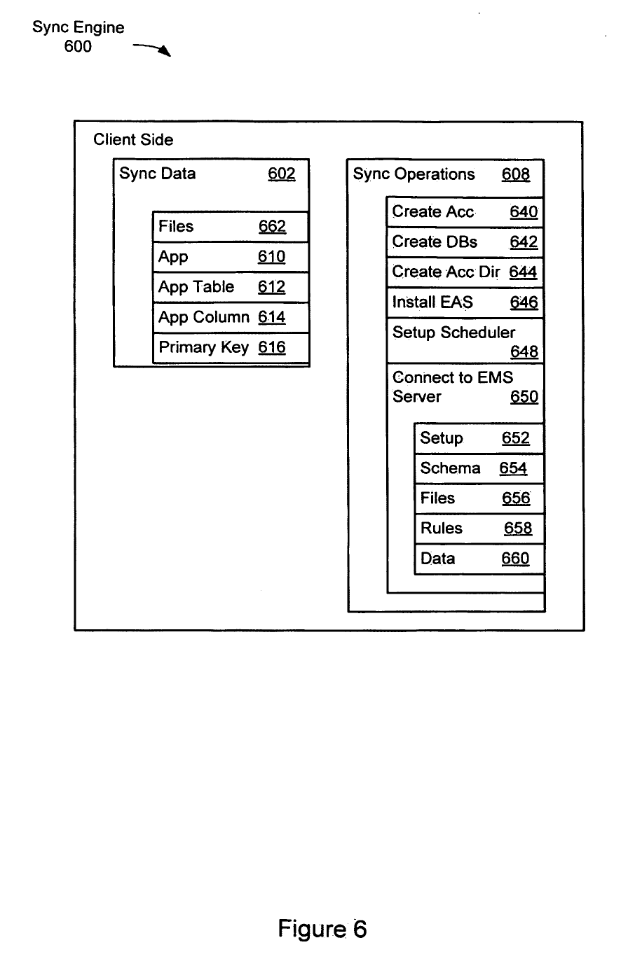

Synchronization application 220 can synchronize a web-based application that is running on a client (e.g., clients 210-B) with a corresponding web-based application running on an application server (e.g., application server 130). Synchronization application 220 is described in more detail below with reference to FIGS. 6 and 23-28.

Traffic management module 222 can manage network traffic between the client and other computer systems. For example, if a user using client 210-A enters a universal resource locator (URL) into browser 212, traffic management module determines an Internet protocol (IP) address for the URL. In some embodiments, traffic management module 222 first looks at a hosts file for client 210-A. The hosts file can map URLs to IP addresses. In some embodiments, for web-based application that are installed on client 210-A, the hosts file can include an entry that associates an IP address for client 210-A (e.g., 127.0.0.1) with the URL. If an entry for the URL exists in the hosts file, traffic management module returns the IP address associated with the URL. If an entry for the URL does not exist in the hosts file, traffic management module 222 can query a dynamic naming service (DNS) server to determine an IP address for the URL. The DNS server may be on client 210-A or may be on a remote DNS server. Note that if a network connection to a remote DNS server does not exist, the client computer system may resort to using the local hosts file and/or the local DNS server to resolve IP addresses. If an entry for the URL is found in a DNS server, traffic management module 222 returns the IP address associated with the URL. If an IP address associated with the URL is not found, an error message can be returned.

License authentication module 224 can be used to verify whether a given user or a given client can use a web-based application loaded on the given client. Copy protection and data security module 226 can protect data that is located in local database 216 and/or local application 214 from being accessed by unauthorized users. For example, copy protection and data security module 226 can protect data by using access control mechanisms to restrict access to data. Alternatively, copy protection and data security module 226 can protect data by encrypting the data. Copy protection and data security module 226 can also work with license authentication module 224 to prevent users that have expired licenses from accessing data stored in local database 216.

As illustrated in FIG. 2, client 210-B is operating in an AOP mode whereas client 210-A is operating in a networked mode. In a networked mode, a user on client 210-A can access a web-based application on application server 130 through network 120. In contrast, a user on client 210-B does not have a connection to application server 130, and thus cannot access functionality for a web-based application that requires a network connection to application server 130. However, since client 210-B has the AOP framework installed, client 210-B can operate in an AOP mode where the full functionality of web-based application (including functionality that normally requires a network connection to application server 130) is available to the user. In some embodiments, a local web server 228 runs web-based application locally. In some embodiments, local web server 228 can be part of stack 218. Note that client 210-A can also include local web server 228. If client 210-A loses a connection to network 120, client 210-A can load the AOP framework and use a local web server to run the web-based application locally until the network connection is restored.

Application server 130 can include one or more of: lightweight directory access protocol (LDAP) gateway 242, web server engine 246, auxiliary services 250, synchronization, access and query engine 260, applications database 262, user database 270, and ecommerce services 280. LDAP gateway 242 can provide directory services to clients through network 120. Note that LDAP gateway 242 is optional in some embodiments.

Web server engine 246 can respond to requests for static web pages, dynamically generated web pages, and web-based applications. These requests can come from clients (e.g., 210-A and 210-B) or from other application servers. In some embodiments, web server engine 246 is an open source web server (e.g., Apache HTTP server). Web server engine 246 can access LDAP gateway 242, auxiliary services 250, user database 270, synchronization, access, and query engine 260, and e-commerce services 280.

Auxiliary services 250 can include, but are not limited to: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption Library), and FreeType (font utilities library).

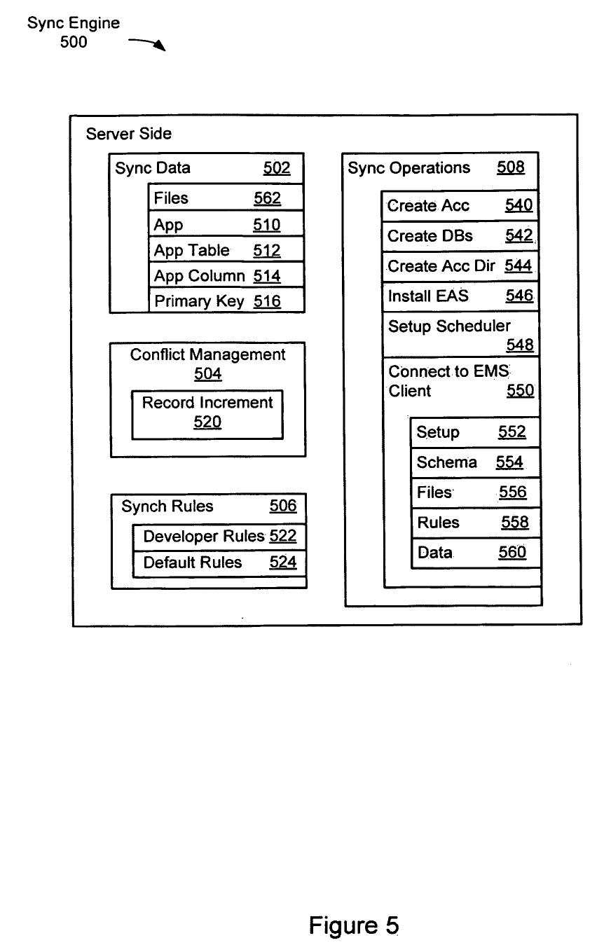

Synchronization, access, and query engine 260 can synchronize data and files between a web-based application hosted on application server 130 and a corresponding web-based application hosted on a client (e.g., clients 210-A and 210-B). Synchronization, access, and query engine 260 can include rules for conflict management and techniques for handling automatically incrementing record identifiers in a database for web-based applications. Synchronization, access, and query engine 260 can access applications database 262, which can include information about web-based applications available on the application server and can include data for the web-based applications. Synchronization, access, and query engine 260 is described in more detail below with reference to FIGS. 5 and 23-28 below. Applications database 262 is described in more detail below with reference to FIG. 3 below.

User database 270 can include information about users. In some embodiments, user database 270 can be used to track users that are allowed to access web-based applications on application server 130. User database 270 is described in more detail below with reference to FIG. 4.

E-commerce services 280 can provide payment-and order fulfillment services. In some embodiments, e-commerce services 280 includes process payment module 282, authenticate license module 284, and serve application module 286. Process payment module 282 can process payments for goods and services. For example, process payment module can authorize payments by credit card, debit cards, electronic funds transfers, or other payment mechanisms (e.g., credits, prepaid tokens, etc.). Authenticate license module 284 can verify that a user has a valid license for a specified service and/or web-based application. E-commerce services 280 can access user database 270 to determine license information and/or payment information. Serve application module 286 can serve applications to a user after a product or service has been purchased or after a license has been verified.

FIG. 3 presents a block diagram of application database 300, according to embodiments of the present invention. Application database 300 includes records 302 to 306 for application 1 to application M, respectively. In some embodiments, applications 1 to application M are web-based applications hosted on an application server. Note that in general there can be any number of applications stored in applications database 300. Each application can have a number of records associated with the application.

Record 302 for application 1 can include information about an application hosted on an application server. For example, record 302 can include, but is not limited to, application name 330, application title 332, application host 334, application user 336, and application password 338. Application name 330 can be a name for the application. Application title 332 can be a title for the application. Application host 334 can be a URL and/or an IP address that is associated with the application on the application server. Application user 336 can be the user or group of users who can manage the application. Application password 338 can be a password for accessing the management features for the application on the application server. Records 304 to 306 for application 2 to application M, respectively, are similar to record 302 for application 1.

Record 1 312 for application 2 can include metadata and content for application 2. For example, record 1 312 can include, but is not limited to, record metadata 350, record log 352, and record content 1 354-1 to record content N 354-N. Record metadata 350 can include information about a given record. For example, the metadata can include, but is not limited to, the date and time the record was created, the user that created the record, and/or the IP address of the user who created the record. Record log 352 can include a log for record 312. For example, record log 352 can be used when synchronizing application 2 between the application server and a client computer system. Record content 1 354-I to record content N 354-N can include content for record 1 312. In some embodiments, record 1 312 to record N 314 can be in the same table within application database 300. In other embodiments, record 1 312 to record N 316 are in different tables within application database 300 or in other databases linked to application database 300. The other records 308-310 and 314-318 arc similar to record 312.

Application index 360 is an index to the applications available in application database 300 (e.g., applications 1, 2, . . . M). For example, applications index can include exemplary applications such as Etelos CRM (ECRM) 370, Media Wiki 372, phpBB3 374, Projects 376, Sugar CRM 378, and/or Wordpress 380.

In some embodiments, each application hosted on an application server is stored in a separate database. These separate databases can be located on the application server or on remote database servers.

Note that the discussion above is one example of an application database. The information included in the application database can include more or fewer records than what are illustrated in FIG. 3.

FIG. 4 presents a block diagram of user database 400, according to embodiments of the present invention. User database 400 includes a number of user records 402-1 to 402-N. User database 400 also includes map 470 which can map user IDs to user records. For example, as illustrated in FIG. 4, map 470 maps user ID 472 to user record 402-2.

User records 402-1 and 402-N are similar to user record 402-2. Thus, the description of user record 402-2 below applies to user records 402-1 and 402-N. User record 402-2 includes, but is not limited to, user ID 410, user metadata 412, query/contact list 414, user client device ID/type 416, user preferences 418, user authentication information 420, user personal information 422, and user enabled features 424. In some embodiments, user ID 410 can be a unique identifier for a user within user database 400. In other embodiments, user ID 410 can be a unique identifier for a user across a specified set of databases (e.g., all or a subset of the database) in the AOP framework. User metadata 412 can include metadata information about the user record. For example, the metadata information can include, but is not limited to, a date and time when the user record was created, a user who created the user record, the IP address of the user who created the user record, etc.

Query/contact list 414 can include queries that are used to retrieve contact records for a user (e.g., user-rule 1 460-1 to user-rule 460-N). The user rules can also be used to retrieve contact information, sales opportunities, filter database information, rules, tasks, appointments, and other contact-related information. For a given contact within query/contact list 414, information related to the contact can be stored in the contact records for the contact. For example, the information can include contact information for the contact (e.g., name, phone number, fax number, address, email address, etc.), action items due to the contact, a last interaction with the contact, etc.

User client device ID/type 416 can store information about the type or IDs of computer devices that the user has used to access applications on the application server. For example, user client device ID/type 416 can indicate that a user used a laptop and a PDA to access applications on the application server. This information can then be used to generate a response that is substantially optimized for the computer device that the user is using to access the application.

User preferences 418 can include preferences for the user. These preferences can be used when generating responses for the user. For example, the preferences can include, font types and sizes, color schemes, etc. User authentication information 420 can be used to authenticate a user. For example, the authentication information can be a username/password combination for the user or can be a digital certificate for the user.

User personal information 422 includes, but is not limited to, name 430, phone number 432 (e.g., home, work, mobile, pager, fax, etc.), email addresses 434, office information 436 (e.g., company name, office address, phone number, fax number, etc.), and/or department 438.

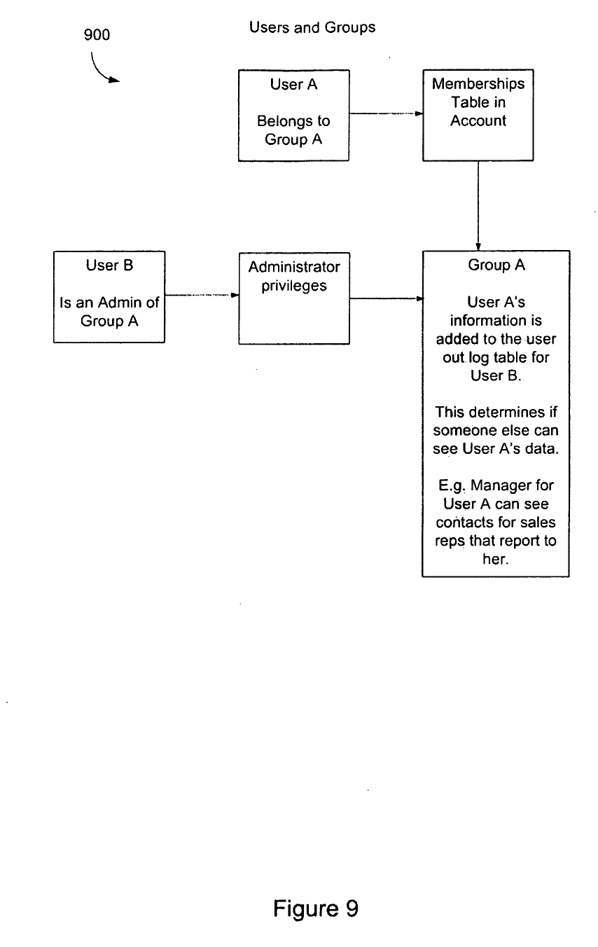

User enabled features 424 includes a list of features on the application server that have been enabled for the user. In some embodiments, user enabled features 424 are determined by the license (e.g., subscription, free, purchased, etc.) granted to the user. In some embodiments, user enabled features 424 are determined by the features that were purchased by the user. In some embodiments, user enabled features 424 are determined by the web-based applications that are available on an application server. Exemplary user enabled features 424 can include, but are not limited to, Application 1 440, Application N 442, EDE 444, Devkit 446, Schedule events 448, user management 450, AOP framework 452, distribute 454, and integrate 456. User management 450 includes a list of rights and privileges for a user. For example, user management 462-1 can include, but is not limited to, administrative rights and access privileges for the user associated with user record 402-2. In some embodiments, these rights and privileges can be determined based on the applications available for the user and/or user enabled features 424. Note that user admin rights and access privileges are described in more detail below with reference to FIG. 9.

Note that the information in the user records can be located within one or more tables of user database 400 and/or in other associated databases. Also note that the discussion above is one example of a user database. The information included in the user database can include more or fewer records than what are illustrated in FIG. 4.

In some embodiments, user database 400 is a distributed database. In some embodiments, user databases 400 can be located on the application server or on remote database servers.

FIG. 5 presents a block diagram of synchronization engine 500 on an application server, according to embodiments of the present invention. Synchronization engine 500 includes a synchronization data module 502, a conflict management module 504, synchronization rules 506, and synchronization operations 508.

Synchronization data module 502 includes data used by synchronization engine 500 to synchronize a web-based application on a client computer system with a web-based application on the application server. As illustrated in FIG. 5, synchronization data module 502 includes files 562, application 510, application table 512, application column 514, and primary key 516.

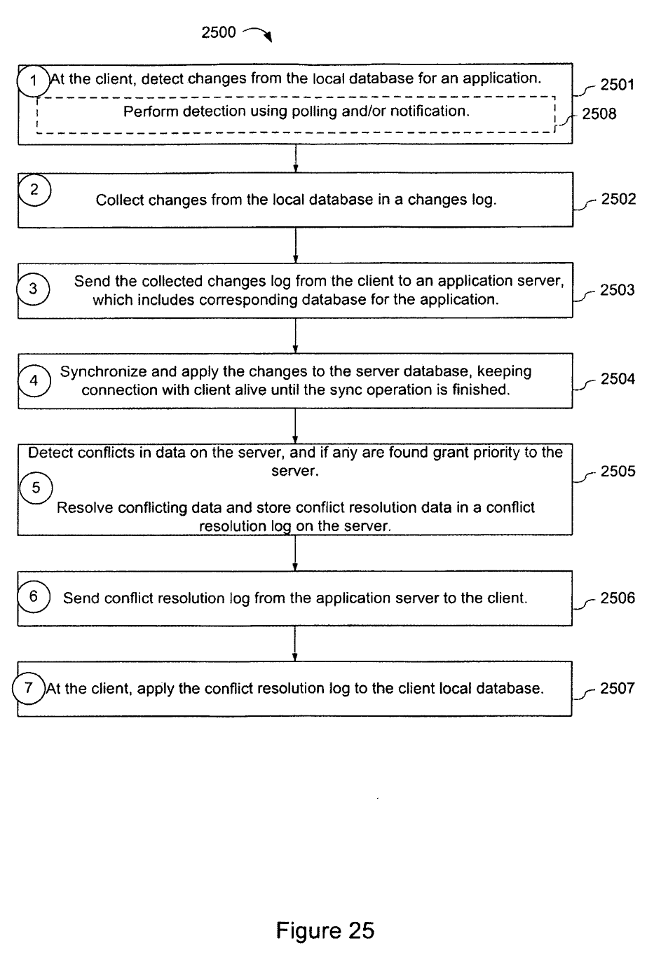

Conflict management module 504 resolves conflicts between the application server and client computer systems. These conflicts can arise when client computer systems operate web-based applications while not connected to the application server. For example, if a web-based application uses an automatically incrementing identifier for database records, client computer systems that are not connected to the application server can unknowingly use the same identifiers as the application server for different data resulting in data conflicts. Thus, in some embodiments, a record increment module 520 is provided to resolve conflicts for web-based application that use automatically incrementing identifiers for database records. Conflict management module 504 and record increment module 520 are described in more detail below with reference to FIGS. 25-28 below.

Synchronization rules 506 are rules used by synchronization engine 500 to determine how to synchronize records between a client computer system and an application server. These rules can include developer specified rules 522 and default rules 524.

Synchronization operations module 508 includes, but is not limited to, create accounts module 540, create databases module 542, create account directories module 544, install EAS module 546, setup scheduler module 548, and connect to EMS client 550. Create accounts module 540 can be used to create accounts for web-based applications. Create databases module 542 can be used to create the databases for web-based applications and the AOP framework. Create account directories 544 can be used to create the directory structure of web-based applications. Install EAS module 546 can be used to install an application server that can be used to serve web-based applications to clients. In some embodiments, the application server module is the Etelos Application Server (EAS) module. Setup schedule module 548 can setup a synchronization schedule between the application server and client computer systems.

Connect to EMS client module 550 can be used to connect an application server with the EMS module on a client computer system. Connect to EMS client module 550 can send data to an EMS module on the client computer system to synchronize the web-based application between the application server and the client computer system. The data can include, but is not limited to, setup data 552, schema 554, files 556, rules 558, and/or data 560.

FIG. 6 presents a block diagram of synchronization engine 600 on a client computer system, according to embodiments of the present invention. The modules in synchronization engine 600 perform similar functions as the modules in synchronization engine 500. For example, synchronization data module 602 generally corresponds to synchronization data module 502 and synchronization operations 608 generally corresponds to synchronization operations 508. As a result, the discussion above for synchronization engine 600 is not repeated.

In some embodiments, the file structures for a web-based application in the application server and the client computer system are similar.

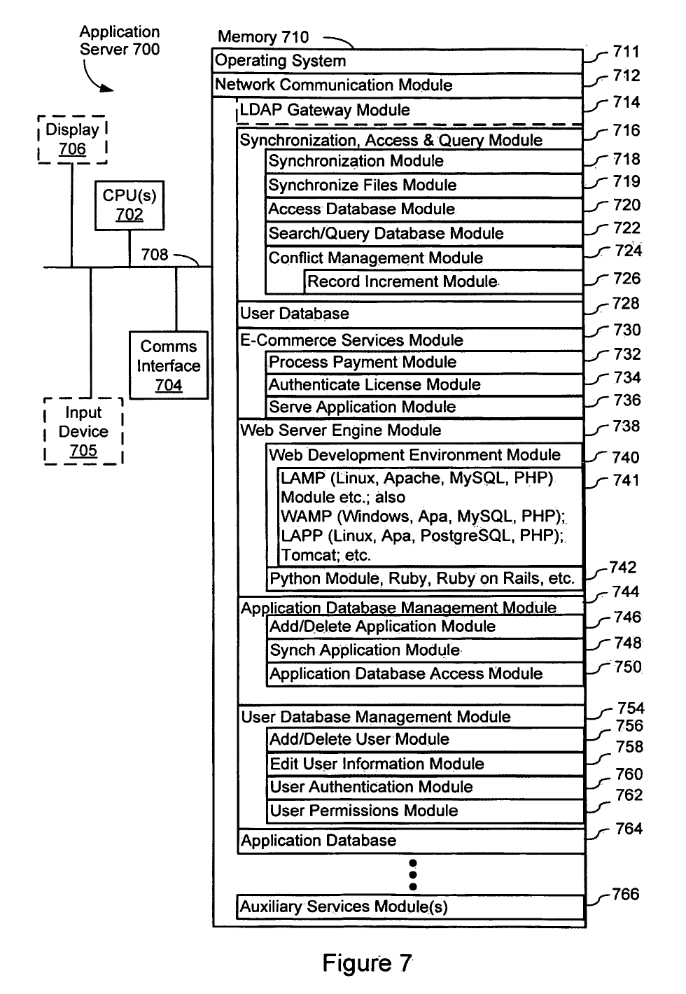

FIG. 7 presents a block diagram of application server 700, according to embodiments of the present invention. The application server 700 generally includes one or more processing units (CPU's) 702, one or more network or other communications interfaces 704, memory 710, and one or more communication buses 708 for interconnecting these components. The communication buses 708 may include circuitry (sometimes called a chipset) that interconnects and controls communications between system components. The application server 700 may optionally include a display 706 and one or more input devices 705 (e.g., keyboard, mouse, trackpoint, etc.). Memory 710 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 710 may optionally include one or more storage devices remotely located from the CPU(s) 702. Memory 710, or alternately the non-volatile memory device(s) within memory 710, comprises a computer readable storage medium. In some embodiments, memory 710 stores the following programs, modules and data structures, or a subset thereof: operating system 711, network communication module 712, LDAP gateway module 714 (optional), synchronization, access and query module 716, user database 728, c-commerce services module 730, web server engine module 738, application database management module 744, user database management module 754, application database 764, and/or auxiliary services modules 766.

Operating system 711 includes procedures for handling various basic system services and for performing hardware dependent tasks. Network communication module 712 can be used for connecting the application server 700 to other computers via the one or more communication network interfaces 704 (wired or wireless) and one or more communication networks, such as the Internet, other wide area networks, local area networks, metropolitan area networks, and so on. LDAP gateway module 714 can provides directory services for application server 700 and other computer systems. In some embodiments, LDAP gateway module 714 is optional.

Synchronization, access, and query module 716 can provides synchronization procedures to synchronize a web-based application on a client computer system with a web-based application on an application server. Synchronization, access, and query module 716 includes one or more of synchronization module 718, synchronization files module 719, access database module 720, query database module 722, and/or conflict management module 724. Synchronization module 718 can perform synchronization operations between a client computer system and application server 700. Synchronization files module 719 synchronizes files between the client computer system and application server 700. Access database module 720 performs read (e.g., select operations) and write operations (e.g., insert, update, and delete operations) on databases. Query database module 722 performs queries in the databases and returns results of the query. Conflict management module 724 resolves conflicts between application server 700 and client computer systems. Conflict management module 724 can include record increment module 726, which can handle conflicts that arise from automatically incrementing identifiers for database records.

User database 728 includes user information as described above with reference to FIGS. 2 and 4. Application database 764 includes application data as described above with reference to FIGS. 2 and 3.

E-commerce services module 730 can provide electronic commerce services. E-commerce services module 730 includes one or more of process payment module 732, authenticate license module 734, serve application module 736. E-commerce services module 730 is described in more detail above with reference to FIG. 2.

Web server engine module 738 can serve web pages to client computer system or other application servers. In some embodiments, web server engine module 738 includes web development environment module 740, which provides software and tools to build and serve web-based applications. In some embodiments, web development environment module 740 is LAMP module 741, which includes the LINUX operating system, Apache HTTP server, the MySQL database management system, and the PHP scripting language.

The components of LAMP module 741 can be substituted for other compatible technologies. In general, LAMP module 741 includes an operating system, a web server, a database, and support for a scripting language. For example, LAMP module 741 can include WAMP (Windows, Apache HTTP, MySQL, PHP) and/or LAPP (Linux, Apache HTTP, PostgreSQL, PHP). LAMP module 741 can also include Apache Tomcat. In some embodiments, web server engine module 734 includes a Python module 742 which supports the Python scripting language. Optionally, Python module 742 can also support Ruby, Ruby on rails, and/or any other languages.

Application database management module 744 provides an interface to manage and access an applications database for web-based applications that are hosted on application server 700. Application database management module 744 can include an add/delete application module 746, a synchronize application module 748, and an application access module 750. Add/delete application module 746 allows for the addition or deletion of web-based application records in application database 764 on application server 700. Synchronize application module 748 synchronizes applications database 764 with an application database on a client computer system. Application access module 750 determines whether a user is allowed to access a given application within application server 700.

User database management module 754 provides an interface to manage and access a user database for web-based applications that are hosted on application server 700. Users database management module 754 can include an add/delete user module 756, an edit user information module 758, a user authentication module 760, and/or a user permissions module 762. Add/delete user module 756 allows for the addition or deletion of users in user database 728 on application server 700. Edit user information module 758 allows for the editing of user information in user database 728. User authentication module 760 authenticates users by checking user credentials stored in user database 728 (e.g., by checking a username and password for a user, or a digital certificate). User permissions module 762 determines whether a user is allowed to access specified resources and/or applications within application server 700.

Auxiliary services module(s) 766 includes, but is not limited to: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption library), and FreeType (font utilities library).

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 710 may store a subset of the modules and data structures identified above. Furthermore, memory 710 may store additional modules and data structures not described above.

Although FIG. 7 shows an “application server,” FIG. 7 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 7 could be implemented on single servers and single items could be implemented by one or more servers. The actual number of servers used to implement an application server and how features are allocated among them will vary from one implementation to another, and may depend in part on the amount of data traffic that the system must handle during peak usage periods as well as during average usage periods.

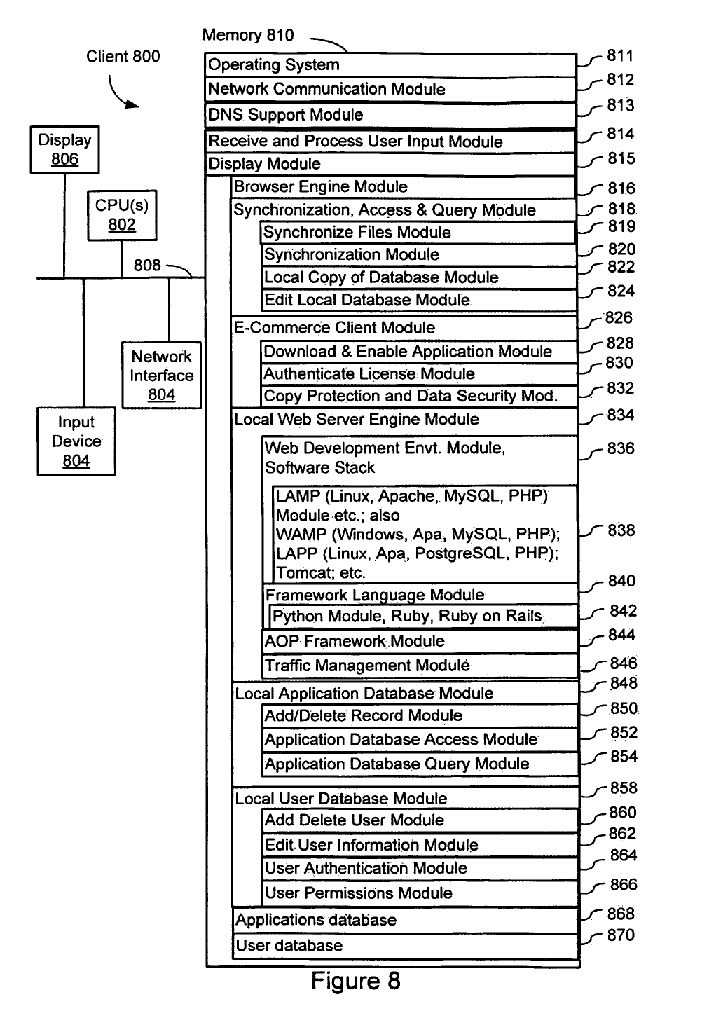

FIG. 8 presents a block diagram of client 800, according to embodiments of the present invention. The client 800 generally includes one or more processing units (CPU's) 802, one or more network or other communications interfaces 804, memory 810, and one or more communication buses 808 for interconnecting these components. The communication buses 808 may include circuitry (sometimes called a chipset) that interconnects and controls communications between system components. The client 800 includes a display 806 and one or more input devices 805 (e.g., keyboard, mouse, trackpoint, etc.). Memory 810 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 810 may optionally include one or more storage devices remotely located from the CPU(s) 802. Memory 810, or alternately the non-volatile memory device(s) within memory 810, comprises a computer readable storage medium. In some embodiments, memory 810 stores the following programs, modules and data structures, or a subset thereof: operating system 811, network communication module 812, DNS support module 813, receive and process user input module 814, display module 815, browser engine module 816, synchronization, access and query module 818, e-commerce client module 826, local web server engine module 834, local application database module 848, local user database management module 858, application database 868, and/or user database 870.

Operating system 811 includes procedures for handling various basic system services and for performing hardware dependent tasks. Network communication module 812 can be used for connecting the client 800 to other computers via the one or more communication network interfaces 804 (wired or wireless) and one or more communication networks, such as the Internet, other wide area networks, local area networks, metropolitan area networks, and so on. DNS support module 813 provides DNS services for client 800. Receive and process user input module 814 receives and processes user inputs received from input devices 805. Display module 815 displays a user interfaces for applications running on client 800. Browser engine module 816 can include any application with a rendering engine that can access data and/or services on a local or a remote computer system and render the results so that a user can view the data and/or interact with the services. In some embodiments, browser engine module 816 is a web browser.

Synchronization, access, and query module 818 can provides synchronization procedures to synchronize a web-based application on a client computer system with a web-based application on an application server. Synchronization, access, and query module 818 includes one or more of synchronize files module 819, synchronization module 820, local copy of database module 822, and edit local database module 824. Synchronization module 820 can perform synchronization operations between client 800 and an application server. Local copy of database module 822 makes a local copy of databases located on an application server. Edit local database module 824 provides an interface to-edit the local copy of the databases.

E-commerce client module 826 can provide electronic commerce services that enable use of web-based applications on client 800. E-commerce client module 826 includes one or more of download and enable application module 828, authenticate license module 830, and/or copy protection and data security module 832. Download and enable application module downloads and enables web-based applications from an application server. Authenticate license module 830 determines whether the license for a web-based application is valid. If so, a user is allowed to access the web-based application. Otherwise, a user is prevented from accessing the web-based application. Copy protection and data security module 832 can protect data that is located in local databases (e.g., an application database or a user database) from being accessed by unauthorized users. Copy protection and data security module 832 can work with authenticate license module 830 to prevent users that have expired licenses from accessing data stored in local databases.

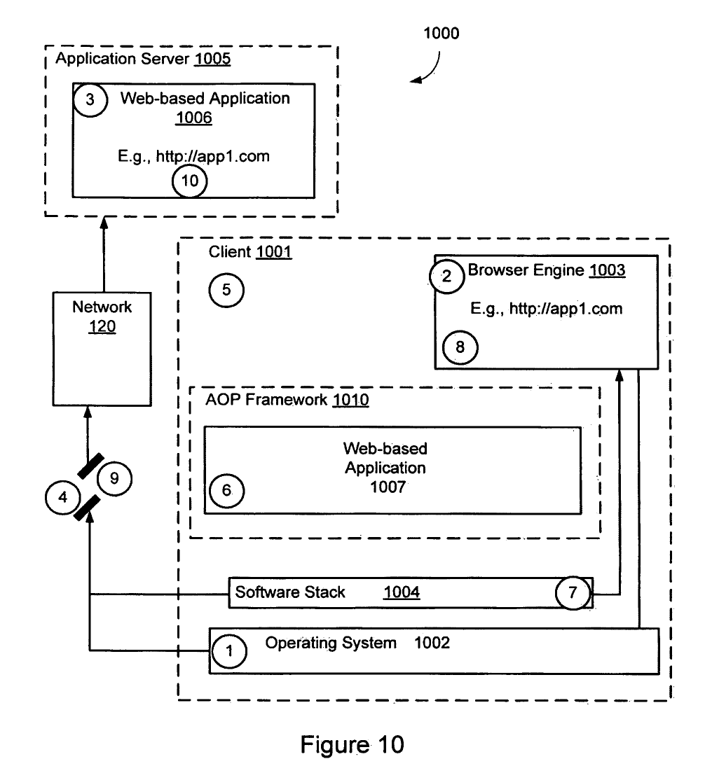

Local web server engine module 834 can serve web pages to client 800 or to other computer systems. In some embodiments, local web server engine module 834 includes web development environment module 836, framework language module 840, AOP framework module 844, and/or traffic management module 846. Web development environment module 836 provides software and tools to build and serve web-based applications. In some embodiments, web development environment module 840 includes a number of open source software (OSS) packages. Thus, web development environment module is sometimes referred to as a software stack. In some embodiments, web development environment module 836 includes LAMP module 838, which includes the LINUX operating system, Apache HTTP server, MySQL database management system, and support for the PHP scripting language and Apache Tomcat. The components of LAMP module 838 can be substituted for other compatible technologies (e.g., WAMP, LAPP, etc.). In general, LAMP module 838 includes an operating system, a web server, a database, and support for a scripting language. Framework language module 840 provides support for one or more programming languages used to implement the AOP framework. In some embodiments, framework language module 840 includes python module 842 which supports the Python, Ruby, and/or Ruby on Rails scripting language. AOP framework module 844 provides data structures and procedures for running web-based applications on a client computer system (e.g., client 800). AOP framework module 844 is described in more detail below with reference to FIGS. 10-28. Traffic management module 846 manages network traffic between client 800 and other computer systems. Traffic management module 846 is described in more detail above with reference to FIG. 2.

Local application database management module 848 provides an interface to manage and access applications database 868 for web-based applications that are hosted on client 800. Local application database management module 848 can include an add/delete record module 850, an application database access module 852, and/or an application database query module 854. Add/delete record module 850 allows for the addition or deletion of web-based application records in application database 868. Application database access module 852 performs reads and writes into application database 868. For example, application database access module 852 can process requests for retrieving data, adding records, deleting records, and editing records. Application database query module 854 performs queries on and returns results from application database 868.

Local user database management module 858 provides an interface to manage and access user database 870 for web-based applications that are hosted on client 800. Local user database management module 858 can include an add/delete user module 860, an edit user information module 862, a user authentication module 864, and/or a user permissions module 866. Add/delete user module 860 allows for the addition or deletion of users in user database 870. Edit user information module 862 allows for the editing of user information in users database 868. User authentication module 864 authenticates users by checking user credentials stored in user database 870 (e.g., by checking a username and password for a user, or a digital certificate). User permissions module 866 determines whether a user is allowed to access specified resources and/or applications within client 800.

Auxiliary services module(s) 864 includes, but is not limited to: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption library), and/or FreeType (font utilities library).

Application database 868 is described in more detail above with reference to FIGS. 2 and 3 above. User database 870 is described in more detail above with reference to FIGS. 2 and 4 above.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 810 may store a subset of the modules and data structures identified above. Furthermore, memory 810 may store additional modules and data structures not described above.

### AOP Framework

FIG. 10 presents a block diagram 1000 of exemplary AOP framework 100 which provides offline access to web-based application 1006, according to embodiments of the present invention. In some embodiments, client computer system 1001 is coupled to application server 1005 through network 120. Network 120 can include, but is not limited to, a local area network (LAN), a wide area network (WAN), the Internet, a mobile network, and/or a wireless network. Client computer system 1001 includes operating system 1002, browser 1003, and AOP framework 1010. As illustrated in FIG. 1, AOP framework 1010 includes software stack 1004 and web-based application 1007. Software stack 1004 may be comprised of open source software, commercial software, or a combination of both. Note that the details of AOP framework 1010 are described in more detail below with reference to FIGS. 10B-28 below. Application server 1005 includes web-based application 1006.

Consider a user who wants to access web-based application 1006 located on application server 1005. For example, the URL for the web-based application can be http://appl.com. The user can use browser engine 1003 on client computer system 1001 to access the URL http://appl.com. When client computer system 1001 has a network connection with application server 1005, application server 1005 can activate web-based application 1006 to respond to the request from browser engine 1003.

On a client computer system without AOP framework 1010, the user can only access the full functionality of web-based application 1006 when there is a network connection between the client computer system and application server 1005. However, since client computer system 1001 includes AOP framework 100, the user can access the fill or substantially the full functionality of web-based application 1006 when there is no network connection between client computer system 1001 and the application server 1005. As illustrated in FIG. 1, AOP framework 1010 includes web-based application 1007, which is a local instance of web-based application 1006. Software stack 1004 provides the software required to execute web-based application 1006 on client computer system 1001. In some embodiments, Software stack 1004 is the same set of software used on application server 1005 to run web-based application 1006.

When client computer system 1001 does not have a network connection with application server 1005, AOP framework 1010 can allow the user to continue having access to the functionality of web-based application 1006 by activating web-based application 1007 on client computer system 1001. Note that the loss of a network connection with application server can result from the user manually disconnecting the network connection (e.g., through software or hardware) or can be a result of external factors (e.g., power outages, network outages, etc.). In some embodiments, AOP framework 1010 automatically activates web-based application 1007 when the network connection to application server 1005 no longer exists. In other embodiments, after the network connection to application server 1005 no longer exists, AOP framework 1010 waits for the user to indicate that web-based application 1007 should be activated.

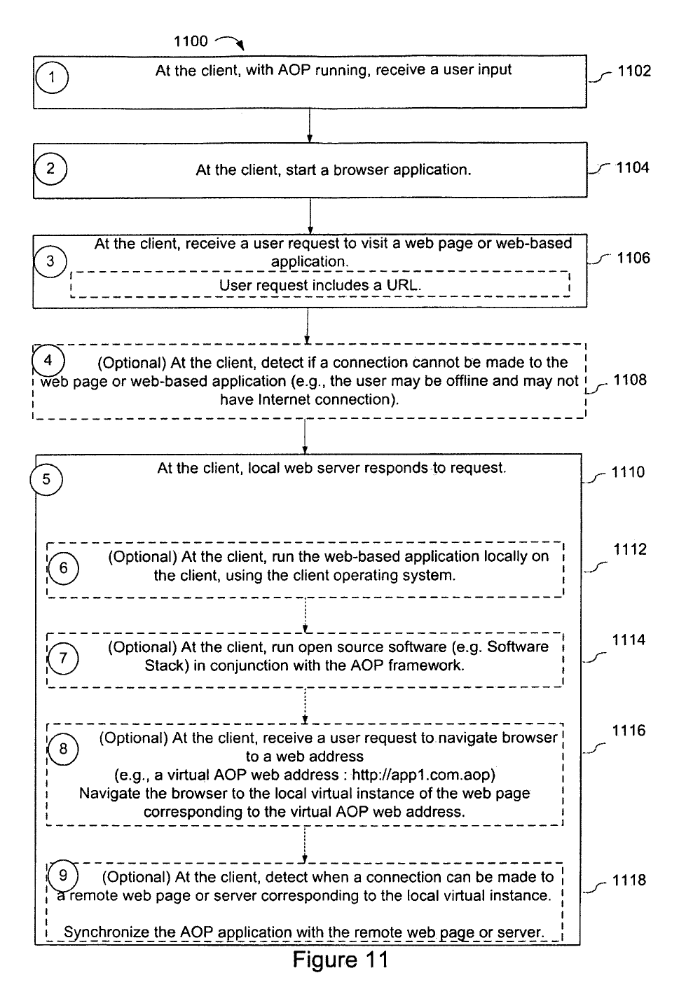

FIG. 11 illustrates an exemplary process 1100 of using AOP framework 1010 to run web-based application 1006 while offline, according to embodiments of the present invention. Note that FIG. 11 corresponds to the block diagram in FIG. 10. The process begins when client computer system 1001 receives an input from a user (1102). Client computer system 1001 starts a browser application (1104). Client 1001 then receives a user request to visit a web page or an application (1106). The user request can include a URL. Optionally, client computer system 1001 then detects if a connection cannot be made to the web page or the application (1108). For example, the user may be offline and may not have an Internet connection. If the connection cannot be made, then a web server on client computer system 1001 responds to the request (1110). Client computer system 1001 can then perform one or more of the optional steps 1112-1118. Client computer system 1001 can run the application locally using the client's operating system (1112). Client computer system 1001 can run the software in conjunction with the AOP framework (1114). Client computer system 1001 can receive a user request to navigate the browser to a web address (e.g., a URL). For example, the URL can be http://appl.com.aop. Note that the extension “.aop” can be replaced with any other extension. AOP framework 1010 can then respond to the request for the specified URL and activates web-based application 1007 to respond to the request. Client computer system 1001 can then detect when a connection can be made to a remote web page or a server corresponding to the local virtual instance (e.g., application server 1005) (1118). When the network connection between client computer system 1001 and application server 1005 is reestablished, any changes made in web-based application 1007 on client computer system 1001 can be synchronized with web-based application 1006 on application server 1005. In some embodiments, client computer system 1001 is synchronized with application server 1005 using Network 120.

In some embodiments, the AOP framework modifies the operating system's network hosts file so that application domains ending with a specified domain suffix are treated as local domains served by a local web server. For example, if the specified domain suffix is “.aop”, an application may have the universal resource locator (URL) “appl.com.aop”. In some embodiments, the local web server is on the same client computer system as the client computer system running the AOP framework. For example, if the AOP framework is running on a laptop, the laptop may also include a local web server.

In some embodiments, when a user attempts to use a browser to access an application that has the specified domain suffix, the request is handled by a local web server and control is delegated to the application associated with the domain name on the client computer system.

In some embodiments, the AOP framework supports web application development languages including, but not limited to, PHP, Python, Ruby, and/or Ruby on Rails.

In some embodiments, the AOP framework determines all local changes made to applications on the client computer system and synchronizes these changes with the application server. In some embodiments, the synchronization is performed on a predetermined frequency. In other embodiments, the synchronization is performed on demand.

### AOP Installation

The AOP framework enables web-based applications to run locally without requiring a network connection to an application server hosting the web-based application. As a result, some embodiments install software packages on a client computer system. These software packages can include, but are not limited to a web server (e.g., Apache HTTP Server), a database (e.g., MySQL, PostgreSQL), application servers (e.g., Apache Tomcat), scripting languages (e.g., Python), and libraries. In some embodiments, the software package includes Apache HTTP server, MySQL, PostgreSQL, Apache Tomcat, Python, and libraries. In other embodiments, the software packages are included in the package for the AOP framework.

FIG. 12 presents a block diagram 1200 of an exemplary process of installing an instance of an AOP framework on a client computer system, according to embodiments of the present invention. The installation process includes downloading OSS packages (1201) and an AOP package (1202), installing the software packages (1203), installing the AOP package (1204), creating an account (1205), initializing an account (1206), connecting to the application server (1207), downloading application files from the application server (e.g., using RPC and SVN through Network 120), and setting up an AOP application on the client computer system (1209).

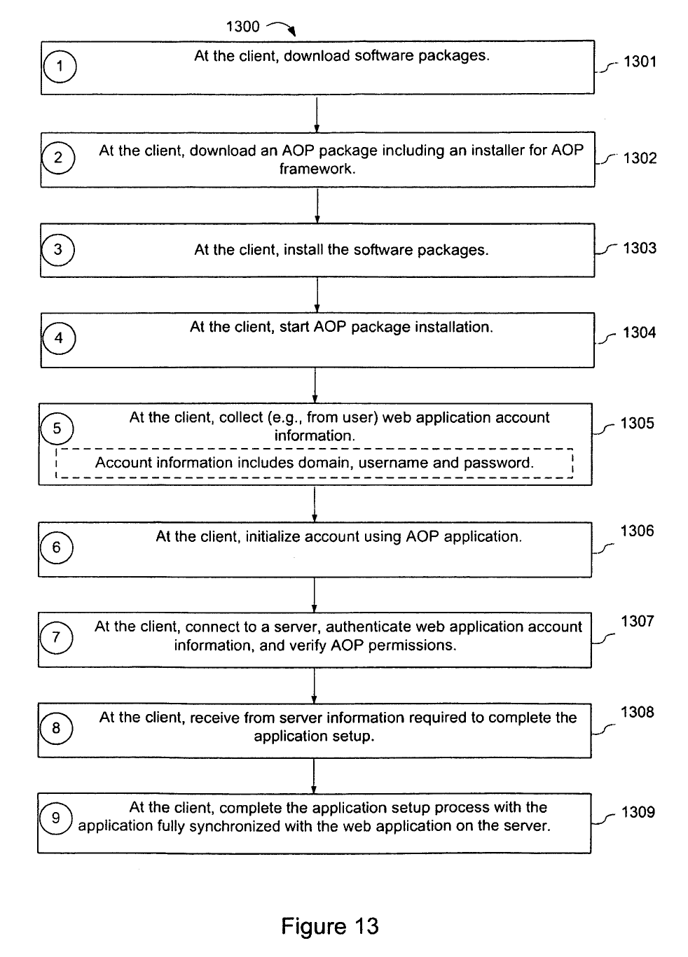

FIG. 13 illustrates an exemplary process 1300 of installing an instance of an AOP framework on a client computer system, according to embodiments of the present invention. Note that FIG. 13 corresponds to the block diagram in FIG. 12. The process begins when a user downloads software packages (1301). The software packages can be included in a single compressed file. The user also downloads the AOP framework package (1302). The AOP framework package can be included in a compressed file. In some embodiments, the AOP framework package includes an installation utility.

The user then installs the software packages on the client computer system (1303). If the software packages are already installed on the client computer system, the software packages are not reinstalled. In some embodiments, if the software packages are already installed on the client computer system, the versions of the software packages installed on the client computer system are determined. The software packages are either updated or not updated based on the determined versions. For example, if a minor software version update occurred for a software package installed on the client computer system, the minor software version update may not be applied. In some embodiments, if the software packages are already installed on the client computer system, the software packages may periodically check for updates and apply the updates according to a set of rules. For example, the set of rules can specify that certain software packages can be updated without user intervention whereas others require specified instructions from users and/or the developers of the web-based application. After the software packages are installed, the user starts the AOP package installation process (1304). The AOP package installation process installs the AOP framework. During the installation process, the user enters account information about web-based applications that the user desires to use (1305). For example, the account information can include one or more of universal resource locator (URL) for the web-based application, a username, and a password.

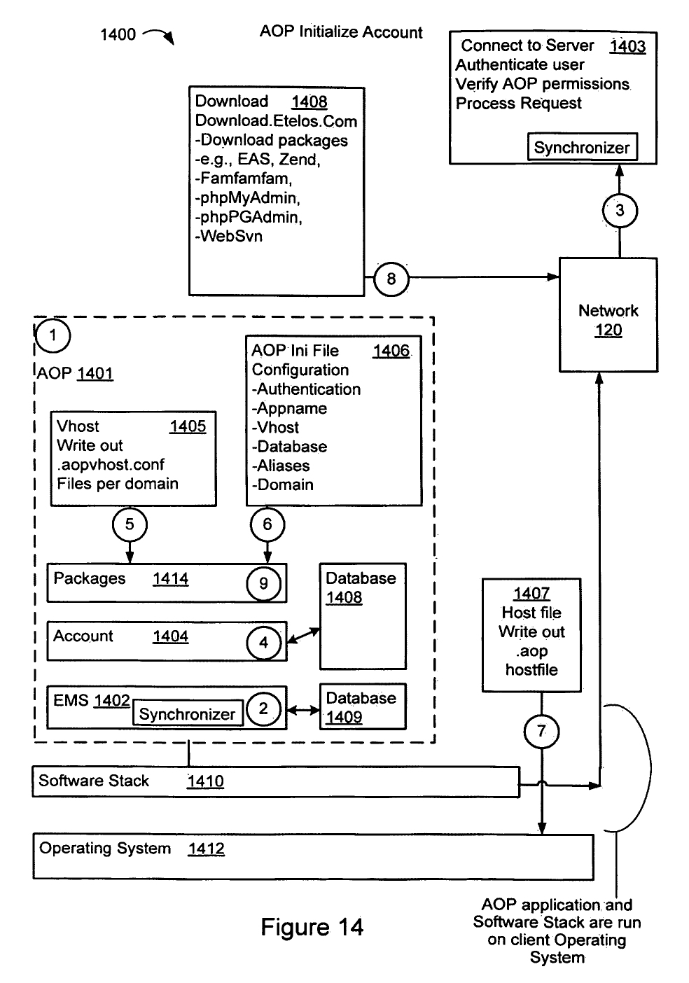

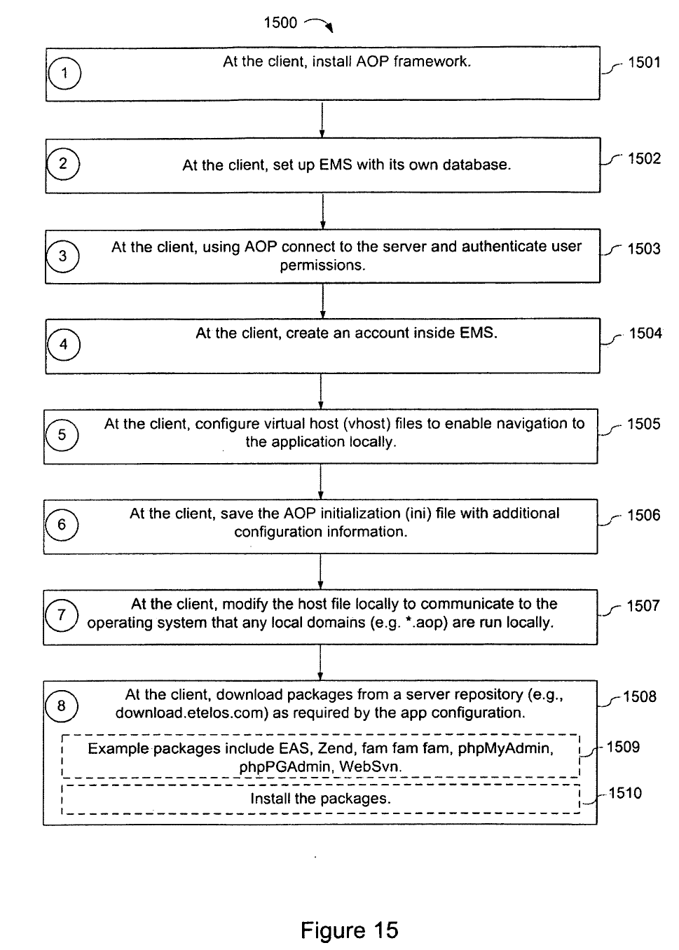

The AOP framework then initializes the account (1306). The account initialization operation is described in more detail with reference to FIGS. 14-15 below.

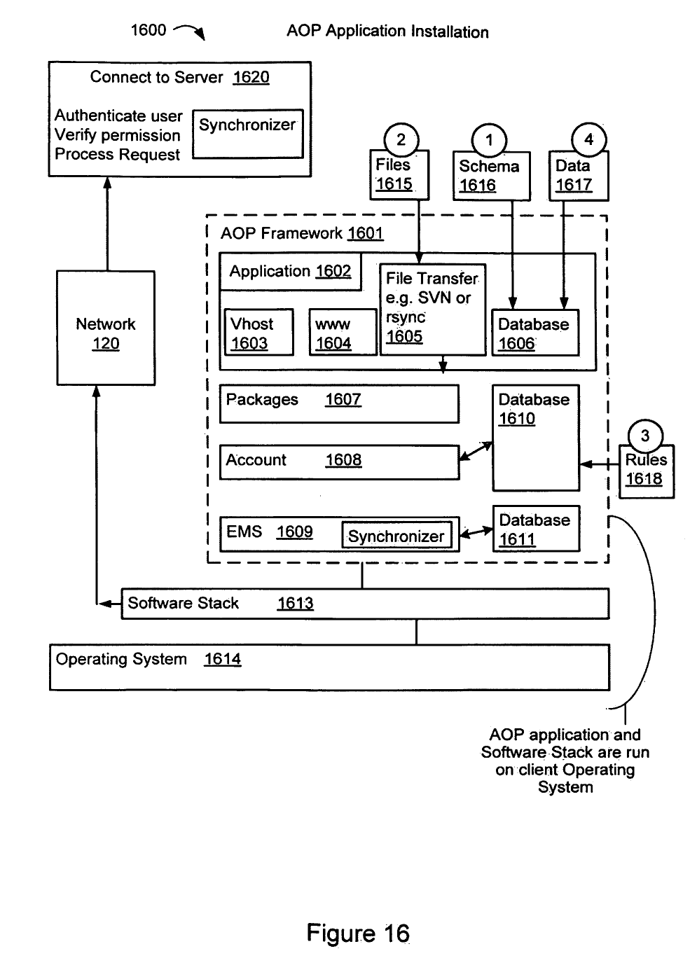

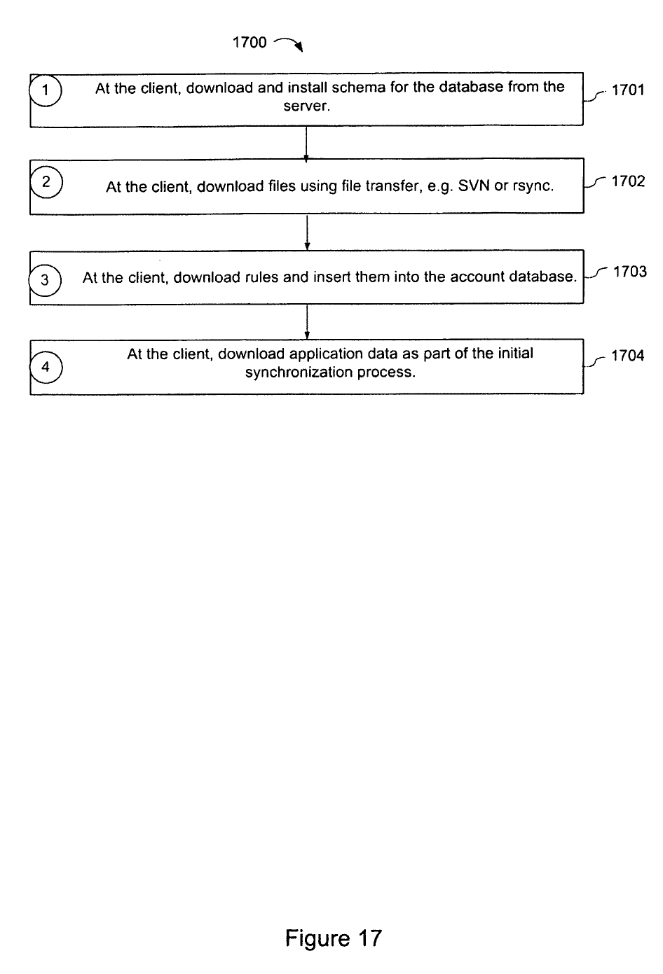

After the account is initialized, the client computer system connects to the application server so that the application server can authenticate the user and verify AOP permissions (1307). After the user has been verified, the application server transfers information required to complete the installation of the web-based application on the client computer system (1308). For example, the application server can transfer files and data for the web-based application to the client computer system. The client computer system then installs up the web-based application (1309). Step 1309 is described in more detail below with reference to FIGS. 16-17.

### AOP Initialize Account

FIG. 14 presents a block diagram 1400 of an exemplary process of initializing an AOP account on a client computer system, according to embodiments of the present invention. FIG. 14 includes AOP application 1401, vhost file 1405, AOP initialization file 1406, database 1408-1409, packages 1414, account 1404, EMS 1402, software stack 1410, operating system 1412, host file 1407, download 1408, connect to server 1403, and Network 120.

FIG. 15 illustrates an exemplary process 1500 of initializing an AOP account on a client computer system, according to embodiments of the present invention. Note that FIG. 15 corresponds to the block diagram in FIG. 14. The AOP framework is installed on the client computer system (1501). After the AOP framework has been installed on the client computer system, a database for an account management system is installed (1502). In some embodiments, the account management system is the Etelos Management System (EMS). The term EMS is used below to describe a generic account management system. The AOP framework connects to the application server and authenticates user permissions (1503). If the user is authenticated, an account is created in the account management system (1504).

The local web server instance within the AOP framework is configured to enable navigation to the web-based application that is installed on the client computer system (1505). In some embodiments, a virtual hosts (vhost) file is configured to map a specified URL to a location for the web-based application on client computer system. For example, the vhost file can map http://appl.com.aop to/web/appl. As noted above, the “.aop” suffix can be any suffix.

An AOP initialization file that includes additional configuration information is saved (1506). The specified URL is then associated with the client computer system (1507). In some embodiments, an entry is added to a hosts file on the client computer system. The entry can be used to redirect a request for the specified URL to the client computer system. In other embodiments, an entry is added to a dynamic naming service (DNS) server on the client computer system. The entry can be used to redirect a request for the specified URL to the client computer system.

Packages that are required by the web-based application are then downloaded from a package repository onto the client computer system (1508). These packages can include packages such as EAS, Zend, fam fam fam, phpMyAdmin, etc (1509). The packages are then installed (1510).

The account is initialized and the system will move onto application installation.

### Web-Based Application Installation

FIG. 16 presents a block diagram 1600 of an exemplary process of installing a web-based application on a client computer system, according to embodiments of the present invention. FIG. 16 includes AOP framework 1601, software stack 1613, operating system 1614, files 1615, schema 1616, data 1617, rules 1618, Network 120, and connect to server 1620. AOP Framework 1601 includes application 1602, packages 1607, account 1608, EMS 1609, and databases 1610-1611. Application 1602 includes vhost 1603, web files 1604, file transfer 1605 (e.g., SVN, rsync, etc.), and database 1606.

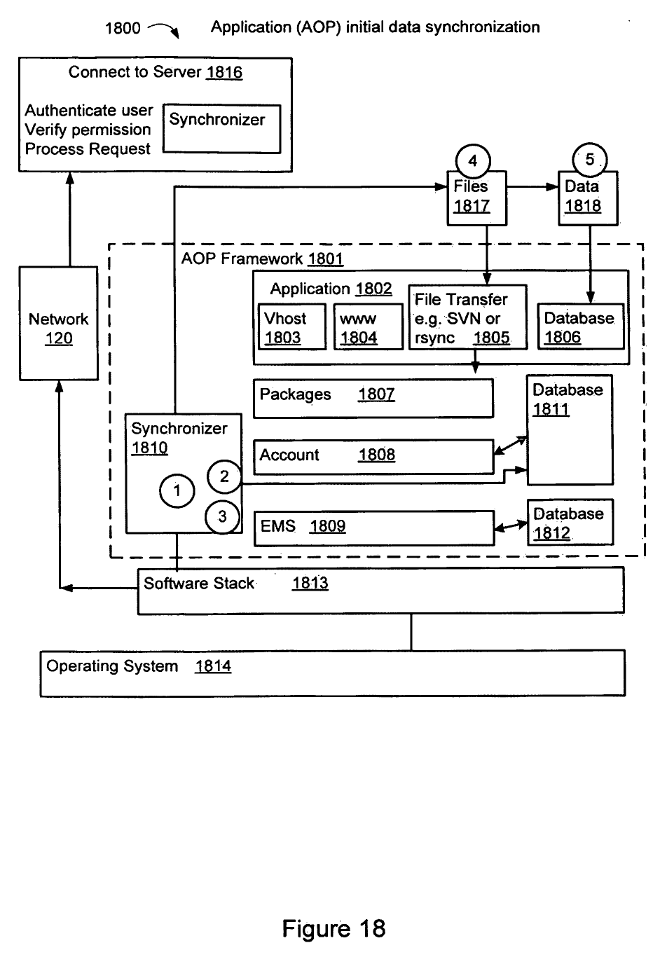

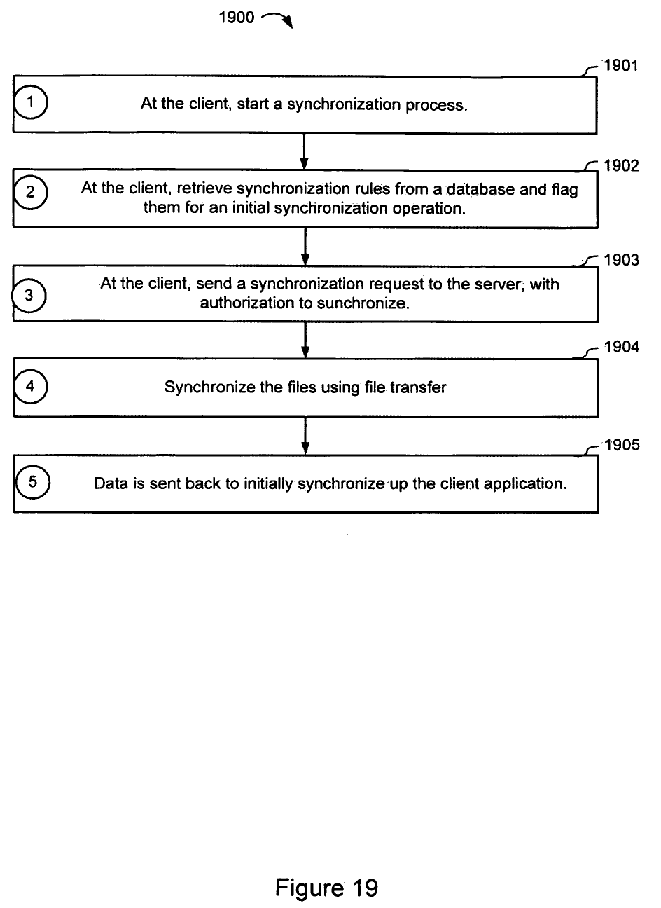

FIG. 17 illustrates an exemplary process 1700 of installing a web-based application on a client computer system, according to embodiments of the present invention. Note that FIG. 17 corresponds to the block diagram in FIG. 16. The client computer system downloads and installs the schema of the database for the web-based application from the application server (1701). The client computer system also downloads the files required by the web-based application (1702). For example, the files can be downloaded using Subversion (SVN), which is a version control system, and/or rsync. The client computer system then downloads synchronization rules and inserts the rules into the database for the account management system (1703). Next, the client computer system downloads application data as part of the initial synchronization process (1704). Step 1704 is described in more detail below with reference to FIGS. 18-19.

### Initial Data Synchronization

FIG. 18 presents a block diagram 1800 of an exemplary process of performing an initial data synchronization for a web-based application on a client computer system, according to embodiments of the present invention. FIG. 18 includes AOP framework 1801, software stack 1813, operating system 1814, files 1817, data 1818, Network 120, and connect to server 1816. AOP Framework 1801 includes application 1802, packages 1807, account 1808, EMS 1809, synchronizer 1810, and databases 1811-1812. Application 1802 includes vhost 1803, web files 1804, file transfer 1805 (e.g., SVN, rsync, and other file transfer tools), and database 1806.

FIG. 19 illustrates an exemplary process 1900 of performing an initial data synchronization for a web-based application on a client computer system, according to embodiments of the present invention. Note that FIG. 19 corresponds to the block diagram in FIG. 18. The initial data sync can be a large and time consuming process because all data records for the web-based application on the application server are synchronized with the web-based application on the client computer system. The synchronization rules processing can be more simple because a new installation typically does not have conflicting data between the application server and the client computer system.

The process begins when a synchronization engine within the AOP framework on the client computer system starts an initial data synchronization process (1901). The synchronizer then retrieves initial data synchronization rules from the database (1902). The synchronizer sends a request to the application server to synchronize with the application server (1903). This request can include user authentication information. Once the user is authenticated, the client computer system synchronizes files for the web-based application using a file transfer utility (1904). For example, the file transfer utility can include Subversion (SNV), rsync, etc. The application server then sends data records to the client computer system (1905). In some embodiments, the data records include all data records for the web-based application.

### Using an the AOP Framework

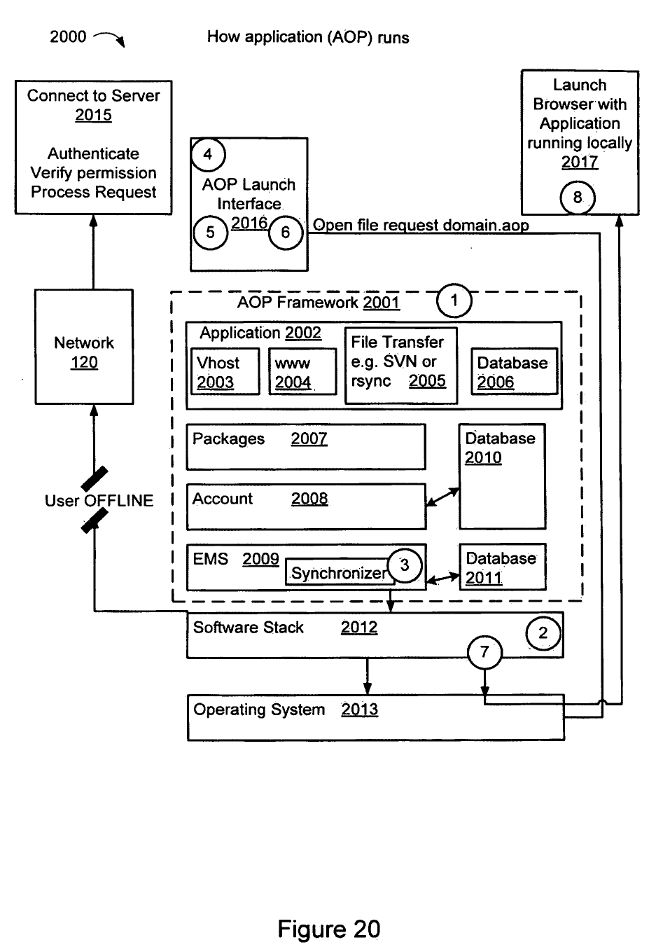

FIG. 20 presents a block diagram 2000 of an exemplary process of using the AOP framework on a client computer system, according to embodiments of the present invention. FIG. 20 includes AOP framework 2001, software stack 2012, operating system 2013, Network 120, connect to server 2015, AOP launch interface 2016, launch browser with application running locally 2017. AOP Framework 2001 includes application 2002, packages 2007, account 2008, EMS 2009, and databases 2010-2011. Application 2002 includes vhost 2003, web files 2004, file transfer 2005 (e.g., SVN, rsycn, and other file transfer tools), and database 2006.

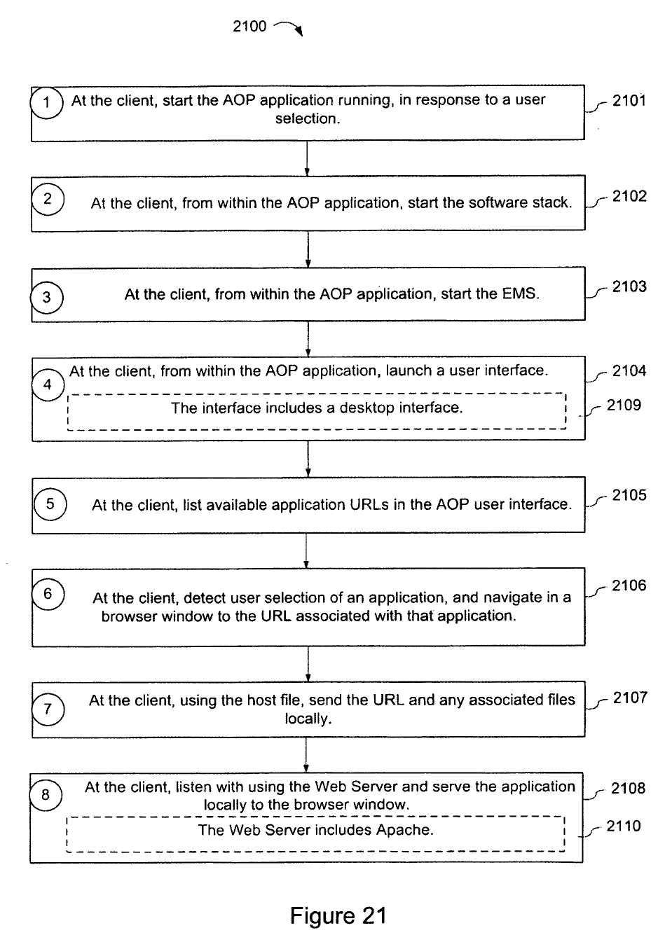

FIG. 21 illustrates an exemplary process 2100 of using the AOP framework on a client computer system, according to embodiments of the present invention. Note that FIG. 21 corresponds to the block diagram in FIG. 20. The AOP framework allows a user to use web-based applications on a client computer system regardless of whether the client computer system is connected to an application server that hosts the web-based application. In order to use web-based applications on the client computer system without a connection to the application server, the AOP framework must be running. A user on a client computer system executes the AOP framework on the client computer system (2101). The AOP framework loads the software stack (2102) and the EMS (2103). The AOP framework then loads a user interface (2104) and web-based applications that are available on the client computer system (2105). In some embodiments, the user interface can include a desktop interface (2109). A user can then select a web-based application to use. This selection is detected and causes the browser to navigate to the URL associated with the selected application (2106). The AOP framework causes the client computer system to be directed to a web server running on the client computer system (2107). For example, an entry in a hosts file or an entry in a DNS server on the client computer system can be used to direct the client computer system to the web server running on the client computer system. The web server on the client computer system listens for connections and responds to a connection request by serving the requested web-based application (2108). In some embodiments, the web server includes Apache HTTP server (2110).

A user that is using a web-based application on the application server can later lose a network connection to the application server. In some embodiments, if the client computer system is running the AOP framework, the user can continue using the web-based application without the network connection to the application server. In these embodiments, the AOP framework can seamlessly continue providing the services required by the web-based application so that the user does not know that the network connection to the application server is lost. After the network connection to the application server is restored, any changes made on the client computer system and the application server can be synchronized with each other.

In some cases, a network connection may be slow or unreliable. Thus, in some embodiments, a user can use a web-based application from the client computer system regardless of whether a network connection to the application server exists or not. In these embodiments, the AOP framework periodically synchronizes changes made on the application server and the client computer system with each other. In doing so, a poor user experience that could result from a low-quality or intermittent network connection can be reduced or eliminated.

In some embodiments, a web browser is used to access the web-based application.

### Client Computer System

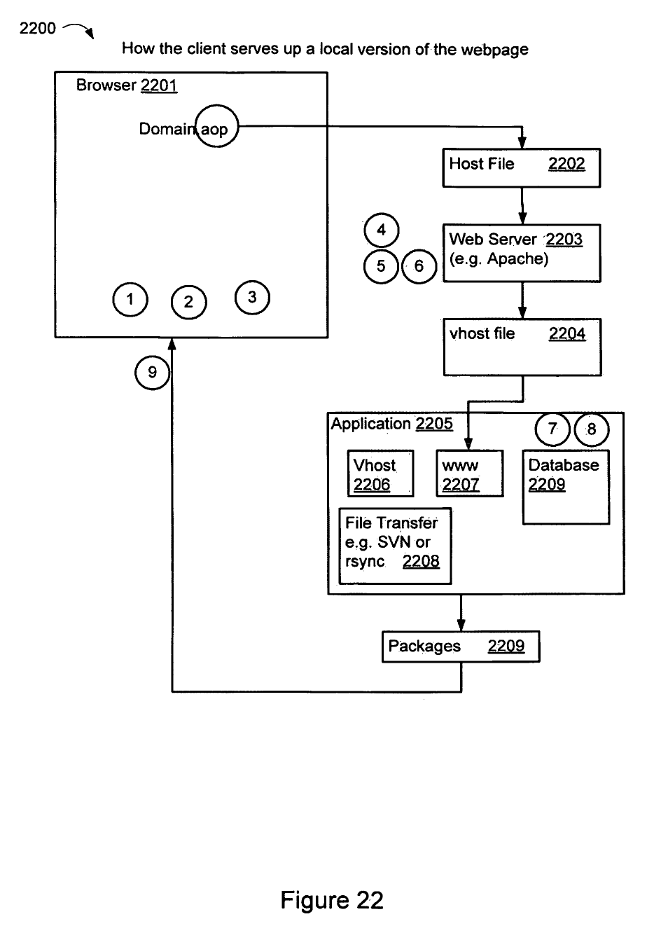

When a user requests a web-based application by entering a URL into a browser, the client computer system determines how to access the web-based application. FIG. 22 presents a block diagram 2200 of an exemplary process for a client computer system determining how to access a web-based application, according to embodiments of the present invention. FIG. 22 includes browser 2201, host file 2202, web server 2203, vhost file 2204, application 2205, and packages 2209. Application 2005 includes vhost 2206, web files 2207, file transfer 2208 (e.g., SVN, rsycn, and other file transfer tools), and database 2209.

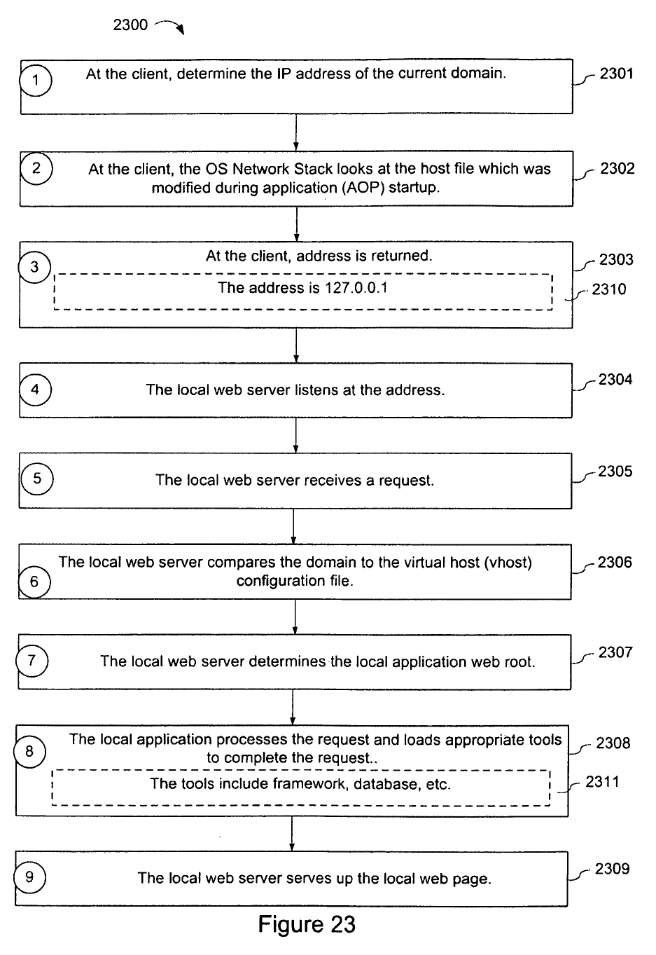

FIG. 23 illustrates an exemplary process 2300 for a client computer system determining how to access a web-based application, according to embodiments of the present invention. FIG. 23 corresponds to the block diagram in FIG. 22. The client computer system first determines an IP address associated with the URL (2301). In some embodiments, the URL includes a domain suffix “.aop”. The client computer system first checks a local hosts file to determine whether the URL is included in an entry in the hosts file (2302). If the URL is not included in an entry in the hosts file, the client computer system checks one or more DNS servers to locate the IP address associated with the URL. If the URL is included in an entry in the hosts file, the client computer system retrieves the IP address for the URL (2303). The IP address for the web-based application is set to an address associated with the client computer system (e.g., 127.0.0.1) (2310). In some embodiments, the IP address associated with the URL for web-based applications is set to an address associated with the client computer system each time the AOP framework is started on the client computer system. In other embodiments, the IP address associated with the URL for web-based applications is set to an address associated with the client computer system when the web-based application is installed on the client computer system.

The web browser is then directed to the IP address associated with the client computer system on which the web server on the client computer system listens (2304). The local web server receives the request (2305) and compares the requested URL to a virtual host (vhost) configuration file (2306) to determine where the files for the web-based application are located on the client computer system (2307) (e.g., the local application web root). The web-based application and tools required to complete the request are loaded (2308). In some embodiments, the tools include the AOP framework, database, etc (2311). The web server then returns a web page with the results of the request (2309).

### AOP Synchronization

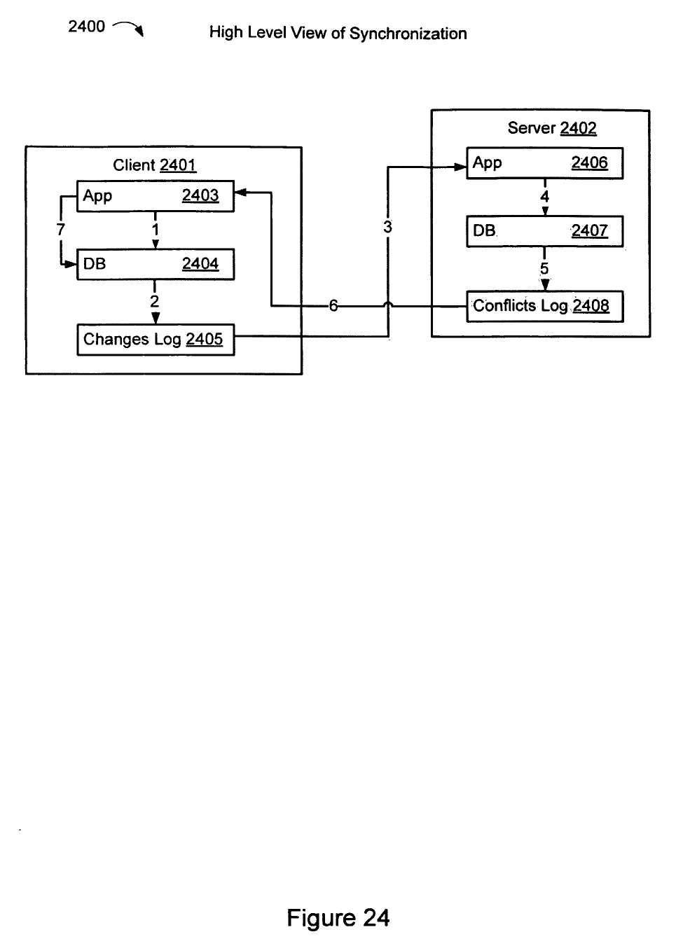

FIG. 24 presents a block diagram 2400 of an exemplary process for synchronizing a web-based application 2403 on a client computer system 2401 with a web-based application 2406 on an application server 2402, according to embodiments of the present invention. As illustrated in FIG. 24, client computer system 2401 includes web-based application 2403, database 2404, and changes log 2405. Application server 2402 includes web-based application 2406, database 2407, and conflicts log 2408. Web-based application 2403 corresponds to web-based application 2406. Similarly, database 2404 corresponds to database 2407.

FIG. 25 illustrates an exemplary process 2500 for synchronizing a web-based application on a client computer system with a web-based application on an application server, according to embodiments of the present invention. FIG. 25 corresponds to the block diagram in FIG. 24. A synchronization process (or a synchronizer module) on the client computer system detects changes in a database 2404 for the client computer system 2401 (2501). In some embodiments, the synchronization process periodically polls database 2404 to determine whether changes have been made (2508). In other embodiments, the synchronization process listens for notification messages which are sent when database 2404 has been changed (2508).

The synchronization process then collects all the changes from database 2404 into a changes log 2405 (2502). The changes are sent to application server 2402 (2503). A synchronization process (or synchronization module) on the application server applies the changes received from the client computer system 2401 to database 2407 (2504). In some embodiments, the connection between client computer system 2401 and application server 2402 is kept alive until the synchronization process is completed.

If conflicts exist between the changes made on client computer system 2401 and application server 2402, the data on the server “wins” (2505). The conflicting data is resolved at application server 2402 and conflict resolution data is collected in a conflict resolution log 2408.

The synchronization process on application server 2402 then sends the conflict resolution log 2408 to client computer system 2401 (2506). The conflict resolution log is applied to database 2407 on client computer system 2401 (2507). Both client computer system 2401 and application server 2402 are synchronized at this point.

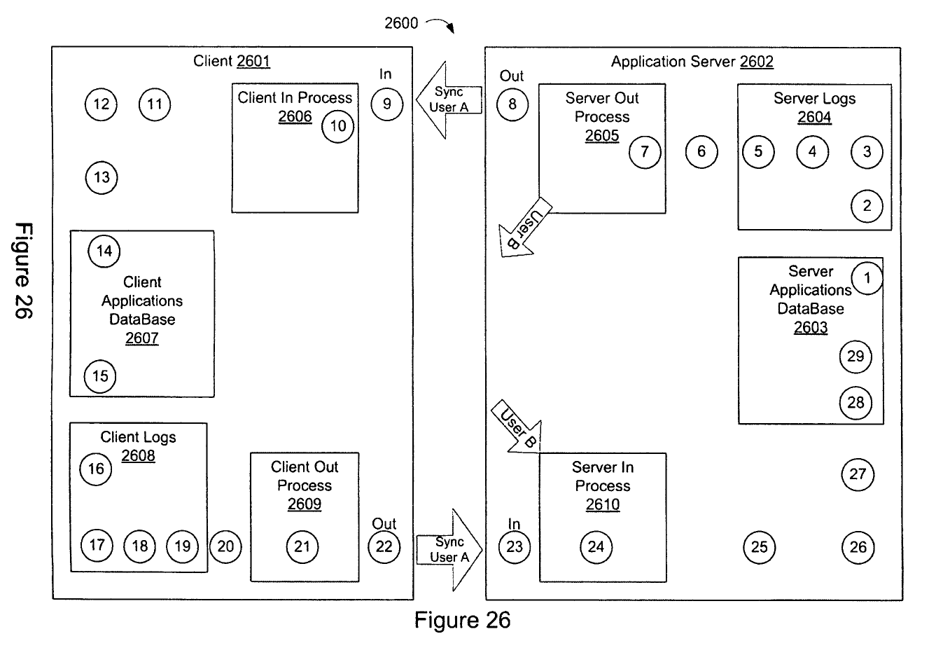

FIG. 26 presents a block diagram 2600 of an exemplary process for synchronizing a web-based application on a client computer system 2601 with a web-based application on an application server 2602, according to embodiments of the present invention. FIG. 26 includes client 2601 and server 2602. Client 2601 includes client in process 2606, client applications database 2607, client logs 2608, and client out process 2609. Application server 2602 includes server applications database 2603, server logs 2604, server out process 2605, and server in process 2610.

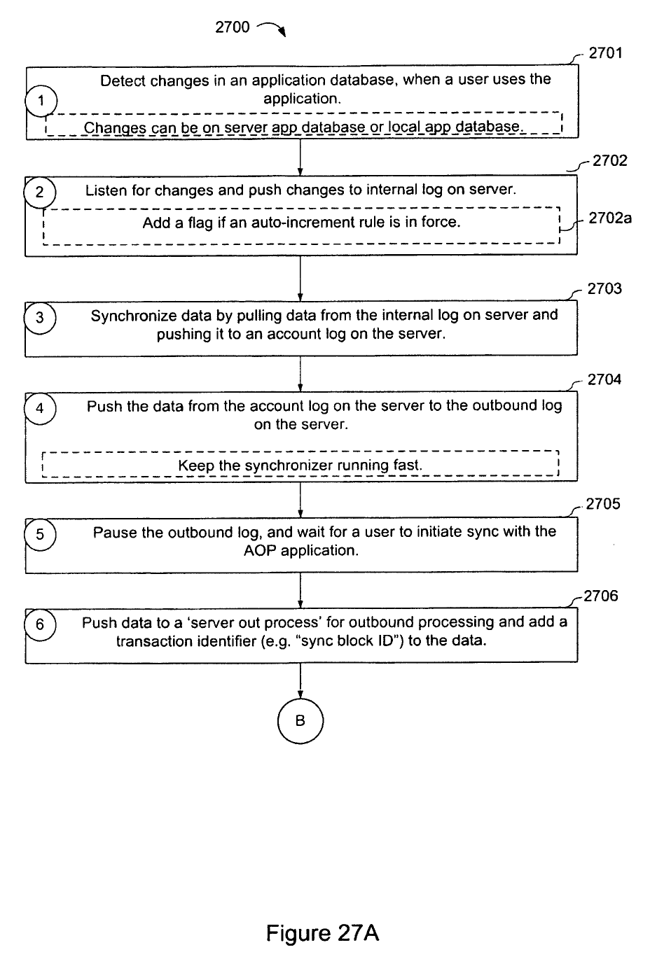

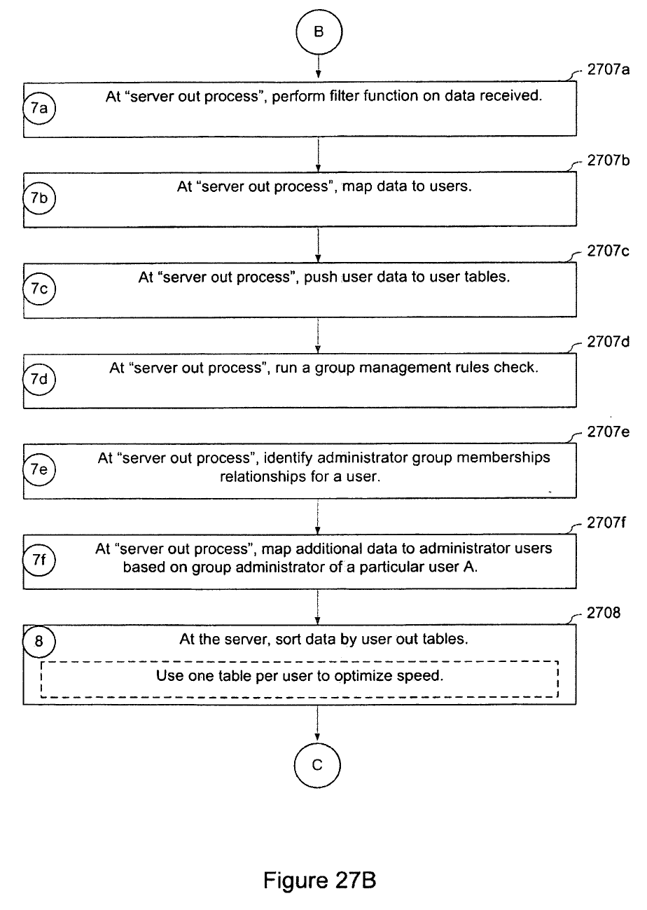

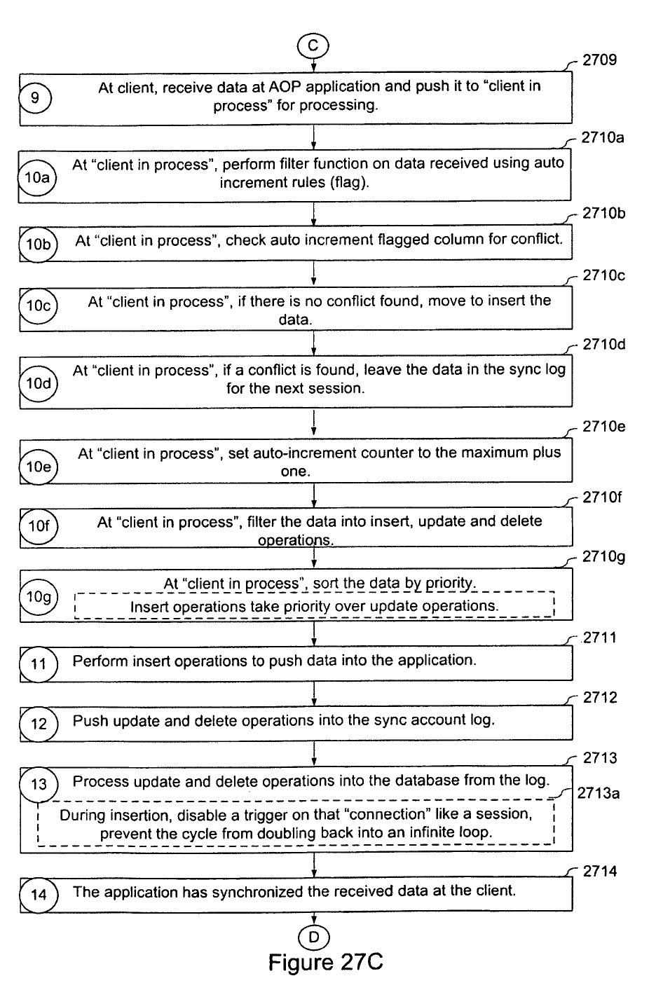

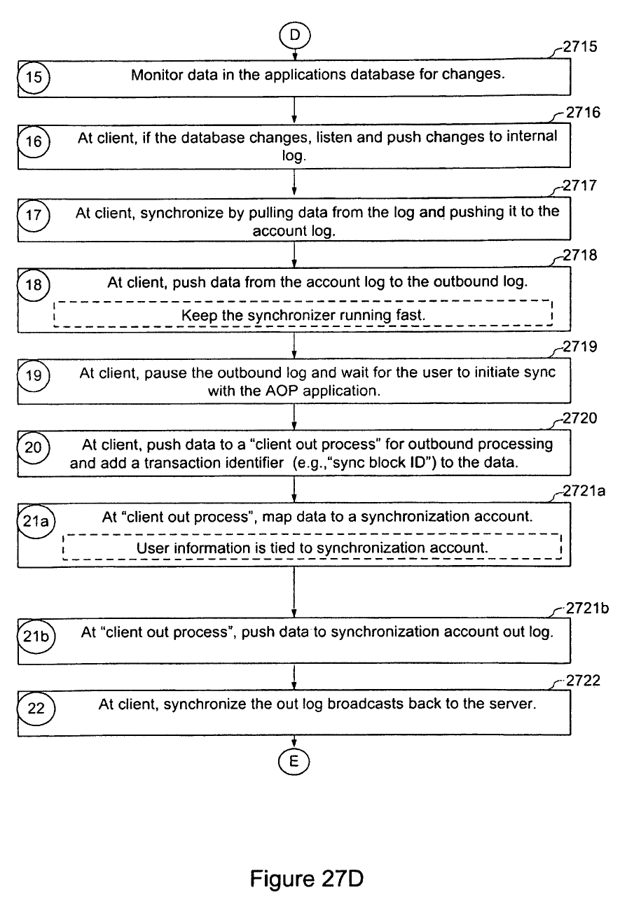

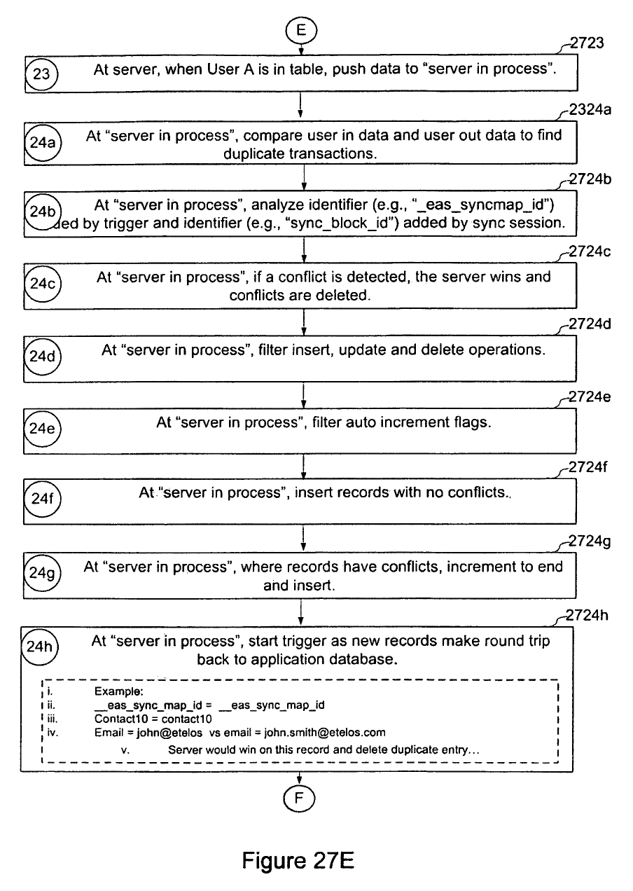

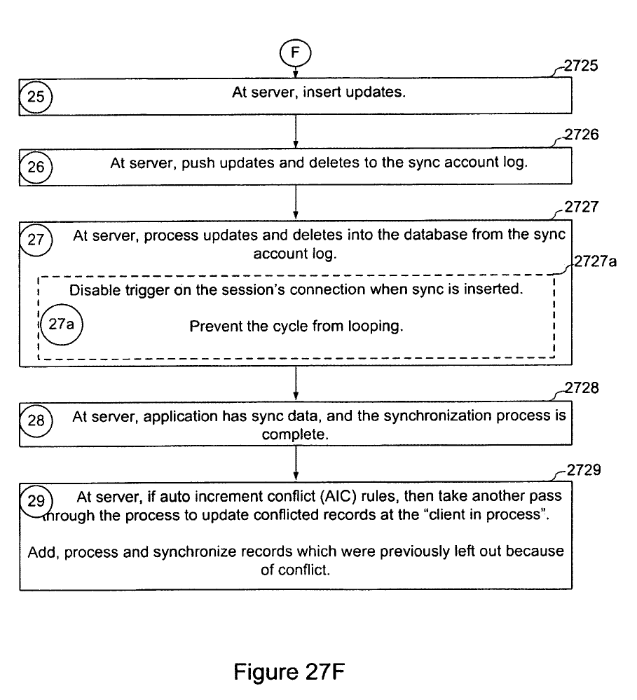

FIGS. 27A-27F illustrate an exemplary process 2700 for synchronizing a web-based application on a client computer system 2601 with a web-based application on an application server 2602, according to embodiments of the present invention. FIG. 27 corresponds to the block diagram in FIG. 26. A user makes changes to the web-based application on application server 2602 (2701). For example, the user can make changes to a database for a web-based application by adding new records or modifying existing records in the database.

Database triggers watch for changes in database 2603 and note these changes in an internal log (2702). In some embodiments, if a rule type is “auto-increment,” then a flag is added to the log (2730). A synchronization process on application server 2602 then pulls data from the internal log, and sends the data to an account log (2703). The data in the account log is then sent to an outbound log (2704). The outbound log is used to speed up the synchronization process because the outbound log can become large and slow to process. The synchronization process then waits for a user to initialize a synchronization operation with the application server (2705).

Once a synchronization operation is started, the data is sent to server out process 2605 for outbound processing (2706). In some embodiments, a transaction id called “sync block ID” is added to the data. The server out process performs several operations (2707), which can include, but are not limited to: applying filters, mapping data to users, sending user data to user tables, running group management rule checks, identifying administrative group memberships relationships for users, and/or mapping additional data to admin users based on a group admin of user A. The data is then sorted by users (2708). In some embodiments, the data is separated into separate “user out” tables, wherein each user has a “user out” table. In doing so, the speed of the synchronization can be optimized.

Client computer system 2601 receives the data and sends the data to client in process 2606 for processing (2709). Client in process 2606 performs a number of operations (2710), including, but not limited to, filtering Auto Increment Rules (flag), checking auto increment (AI) flagged column for conflict, marking data as “insert” if there are no conflicts, marking data in the sync log as “leave” (which are processed in the next session) if there are conflicts (see 2724), setting an auto-increment counter to max+1, filtering data into inserts, updates and deletes, and/or sorting priorities (e.g., inserts before updates).

The synchronization process then inserts data that is marked as “insert” into client applications database 2607 for the web-based application (2711). The synchronization process then sends data that is marked as “update” or “delete” to a sync account log (2712). The updates and deletes in the sync account log are then processed by client applications database 2607 (2713). In some embodiments, when the synchronization process inserts data, the synchronization process disables triggers within a synchronization session to prevent doubling back into an infinite loop (2713a). The web-based application on client computer system 2601 is now synchronized with the web-based application on application server 2602 (2714).

A user using web-based application on client computer system 2601 changes data in client applications database 2607 for the web-based application (2715). Database triggers watch for changes in client applications database 2607 and notes these changes in an internal log (2716). A synchronization process on client computer system 2601 then pulls data from the internal log and sends the data to an account log (2717). The data in the account log is then sent to an outbound log (2718). The outbound log is used to speed up the synchronization process because the outbound log can become large and slow to process. The synchronization process then waits for a user to initialize a synchronization operation with the application server (2719).

Once a synchronization operation is started, the data is sent to client out process 2609 for outbound processing (2720). In some embodiments, a transaction id called “sync block ID” is added to the data. Client out process 2609 performs several operations (2721), including, but not limited to, mapping data to sync account (user info is tied to sync acct) and/or pushing data to the sync account out log. Sync account out log is broadcast to application server 2601 (2722).

In some embodiments, every user has a table associated with the user (e.g., “in-table”), which is used for inbound processing. User in-tables (e.g., user A in-table, user B in-table) are pushed to server in process 2610 (2723). Server in process 2610 performs a number of operations (2724), including, but not limited to, comparing data—user out and user in—duplicate transactions, based on_eas_syncmap_id (added by trigger) and “sync_block_id” added by sync session, server wins—so server deletes conflicts, filtering inserts from updates and deletes, filtering auto increment flags, inserting records with no conflict, and/or inserting records with conflicts at the next unused record. Several examples of conflicting records include: _eas_sync_map_id=_eas_sync_map_id, Contact10 =contact10, and Email=john@etelos vs. email=john.smith@etelos.com.

Data records that are marked as “insert” are inserted (2725). Data records that are marked as “update” or “delete” are sent to a sync account log (2726). The updates and deletes in the sync account log are then processed by server applications database 2603 (2727). In some embodiments, when the synchronization process inserts data, the synchronization process disables triggers this synchronization session to prevent doubling back into an infinite loop (2732). The web-based application on application server 2602 is now synchronized with the web-based application on client computer system 2601 (2728).

If the automatic incrementing rules detect a conflict between application server 2602 and client computer system 2601, another pass is taken through the process to update conflicted records (2729). During this process, records that were previously left out because of conflicts are synchronized.

In some embodiments, the synchronization process can be used to synchronize between different types of database management systems (DMBSs). In some embodiments, the synchronization process can be used to synchronize between the same type of DBMSs. In some embodiments, the changes are synchronized directly with a DBMS associated with the web-based application. In all of these embodiments, database drivers are used to perform the synchronization between the DBMSs. The database drivers can handle the translations of data between different types of DBMSs as well as determining what changes occurred since the last synchronization process.

In some embodiments, the synchronization process synchronizes directly with the file structures associated with the web-based applications. In these embodiments, a file synchronization utility such as SVN or rsync can be used to synchronize the file structures.

### Auto Increment Conflict Resolution

Some web-based applications use automatically incrementing identifiers in a database when a new record is added to the database. In these web-based applications, conflicts can arise if multiple instances of the web-based application (e.g., on the application server, on multiple client computer systems, etc.) are all inserting new data records into a database for that instance of the web-based application. Thus, some embodiments provide a technique to resolve conflicts for web-based application that use auto-increment identifiers.

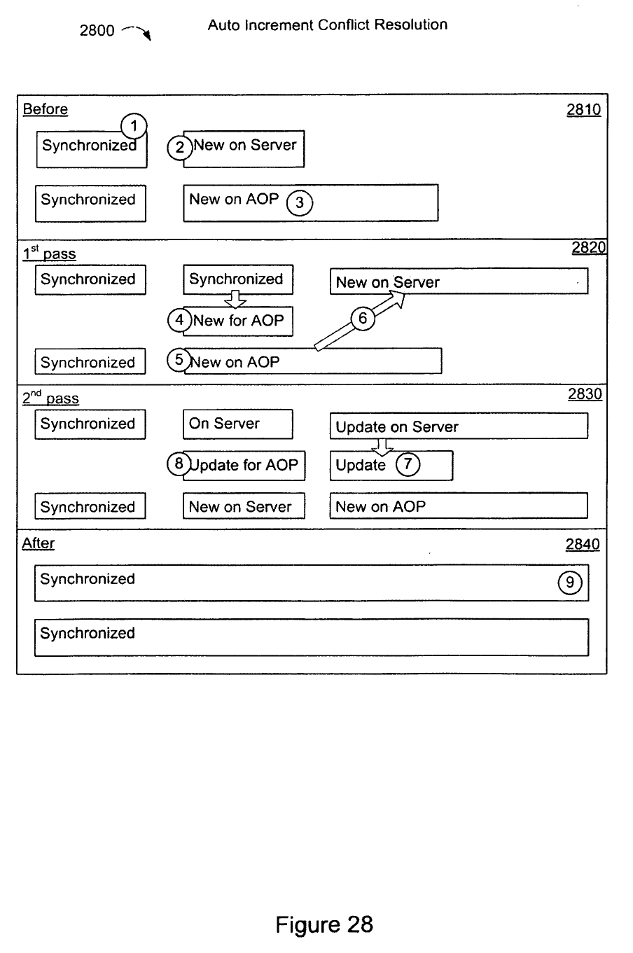

FIG. 28 presents a block diagram 2800 of an exemplary process for resolving conflicts for web-based applications that use auto-incrementing identifiers, according to embodiments of the present invention. FIG. 28 illustrates the state of data on an application server and a client computer system at several points in time (e.g., before synchronization, after a first pass of synchronization, after a second pass of synchronization, and after synchronization is complete).

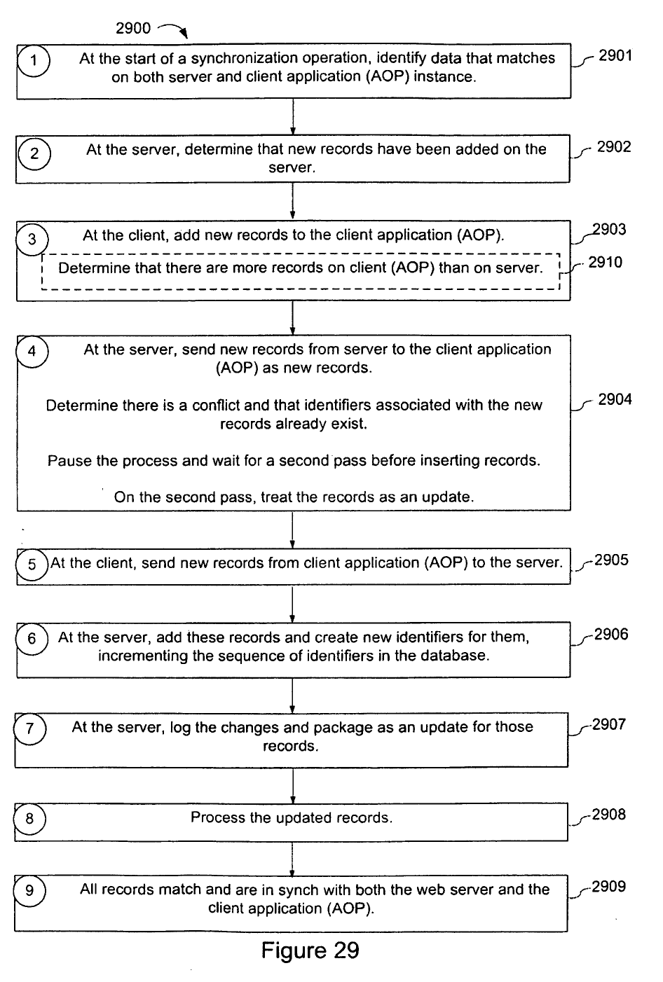

FIG. 29 illustrates an exemplary process 2900 for resolving conflicts for web-based applications that use auto-incrementing identifiers, according to embodiments of the present invention. FIG. 29 corresponds to the block diagram in FIG. 28. As illustrated in FIG. 29, both the application server and the client computer system have added new records into their respective databases for the web-based application. The application server and the client computer system also have records that are already synchronized. Note that in FIG. 29, the identifiers increase from left to right. Thus, the new records on the application server and the client computer system include a number of records that use the same identifiers, resulting in conflicts.

At the start of a synchronization operation, the data that is already synchronized on both the application server and the client computer system (e.g., the AOP instance) is identified (2901). The application server then determines that new records have been added to the application server since the last synchronization with the client computer system (2902). The client computer system determines that new records have been added to the client computer system since the last synchronization with the application server (2903).

The conflict resolution process begins when the application server sends its new records to the client computer system (2904). Since there is a conflict between the identifiers used in the application server and the client computer system, the conflict resolution process waits for a second pass before inserting the new records received from the application server. On the second pass, the new records from the application server are treated as an update.

The client computer system sends its new records to the application server (2905). The application server assigns new identifiers for these records and inserts these records into the database for the web-based application (2906). The application server can assign the new identifiers for these records by using the automatically incrementing identifiers in the database. The application server then generates an update log that includes the changes for these records (2907). The application server sends the update log to the client computer system which then processes updates from that result from these records and from the new records received from the application server at step 2804 (2908). The records in both databases are now synchronized (2909).

### Users and Groups

FIG. 9 presents a block diagram illustrating exemplary group memberships for users for a given web-based application, according to embodiments of the present invention. As illustrated in FIG. 9, user A is a member of group A. This membership can be managed through a memberships table. User B is a member of a group of administrators that are administrators of group A. This administrator membership can be managed through an admin table. In some embodiments, changes to user A's information are also added to a user out log table for user B. Thus, user B can see changes that user A has made. For example, a sales manager can view contacts for sales representatives that report to the sales manager.

In some embodiments, a group sync app group filter is used to indicate whether the web-based application supports group memberships. These rules can be setup in the account database for the web-based application. The filter can include information such as a data table (e.g., a contacts table), a membership table (e.g., the membership table), and a group table (e.g., groups). This can be a one time setup that a developer of a web-based application does to configure the web-based application to synchronize with the AOP framework. In some embodiments, the filter is setup when the developer ports the application to the AOP framework environment.

In some embodiments, the group filter sets flags in database triggers to send memberships data with a log entry so that the AOP framework knows what to use to filter in the server out process. In other words, the group filter is used to indicate which table includes user information, whether there is a membership table for linking users to groups, and the table that keeps track of groups.

### Rules Setup

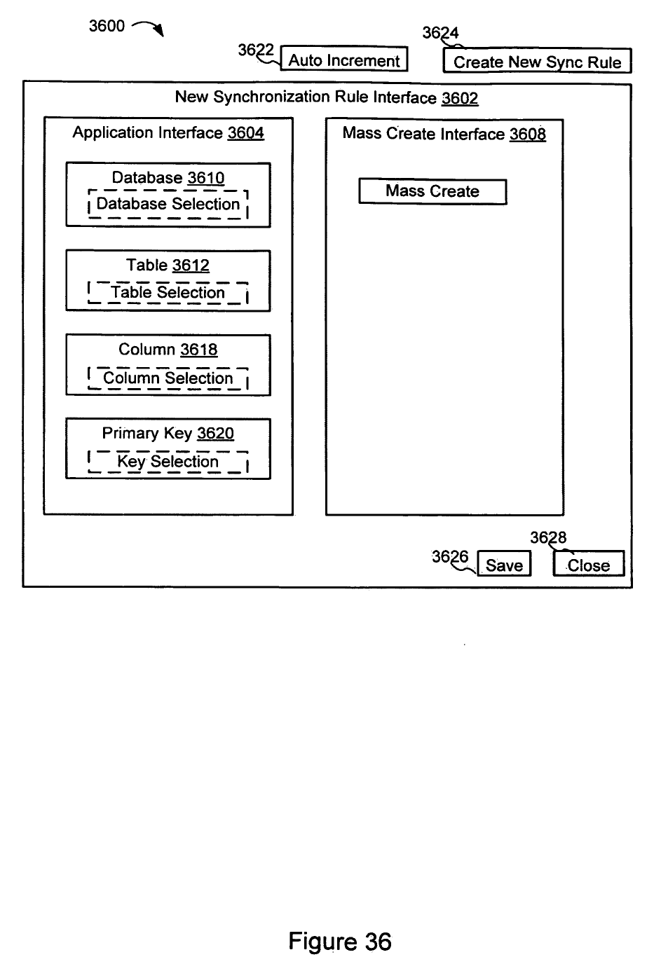

FIG. 36 presents a block diagram 3600 illustrating an exemplary user interface 3600 for creating synchronization rules, according to embodiments of the present invention. User interface 3600 includes one or more of: new synchronization rule interface 3602, auto increment function 3622, and/or create new sync rule function 3624. New synchronization rule interface 3602 includes one or more of: application interface 3604, mass create interface 3608, save function 3626, and/or close function 3628.

Application interface 3604 includes one or more of database function 3610, table function 3612, column function 3618, and/or primary key function 3620. Database function 3610 allows a user to select available databases. Table function 3612 allows a user to select tables within the available databases. Column function 3618 allows a user to select columns within the tables. Primary key function 3620 allows a user to select primary keys for the tables. Using these functions, a user can specify synchronization rules on one or more of the database level, the table level, the column level, and the primary key level.

Mass create interface 3608 includes a mass create function which allows a user to automatically create sync rules for the AOP framework at every match for a specified level. For example, a user can use the mass create function to create sync rules for all database tables.

Auto increment function 3622 allows a user to specify which columns on a given table use automatically incrementing identifiers. Create new sync rule 3624 creates the new synchronization rule specified by the user in user interface 3600. Save function 3626 saves the new rule whereas close function 3628 closes user interface 3600.

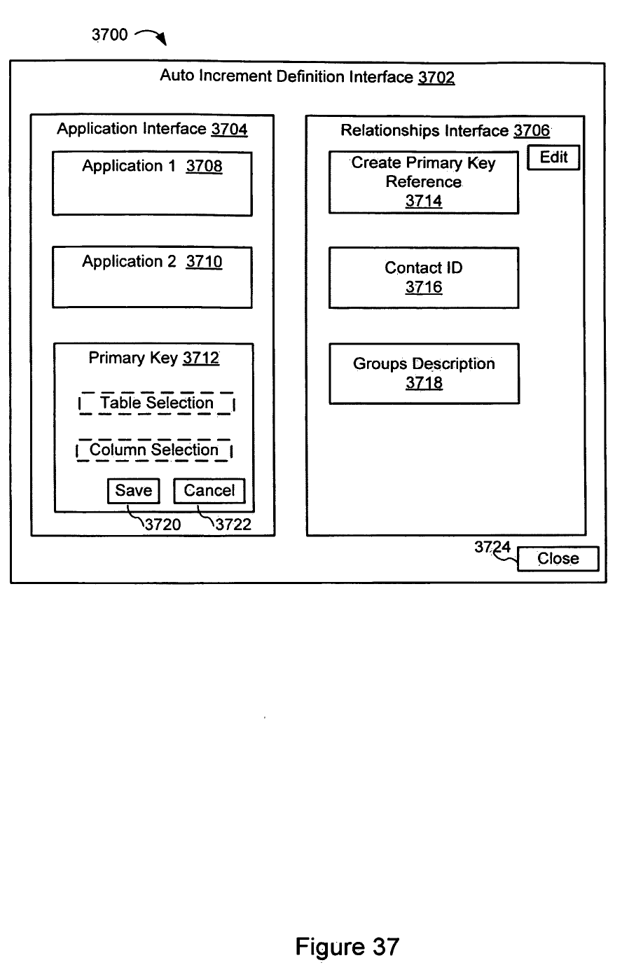

FIG. 37 presents a block diagram 3700 illustrating an exemplary user interface 3700 for generating auto-incrementing identifiers, according to embodiments of the present invention. User interface 3700 includes auto increment definition interface 3702, which includes one or more of application interface 3704, relationships interface 3706, and/or close function 3724. Application interface 3704 includes one or more of application 1 3708, application 2 3710, and/or primary key 3712. Primary key 3712 includes one or more of a table selection function, a column selection function, save function 3720, and/or cancel function 3722. Relationships interface 3706 includes one or more of create primary key reference function 3714, contact ID function 3716, groups description function 3718, and an edit function.

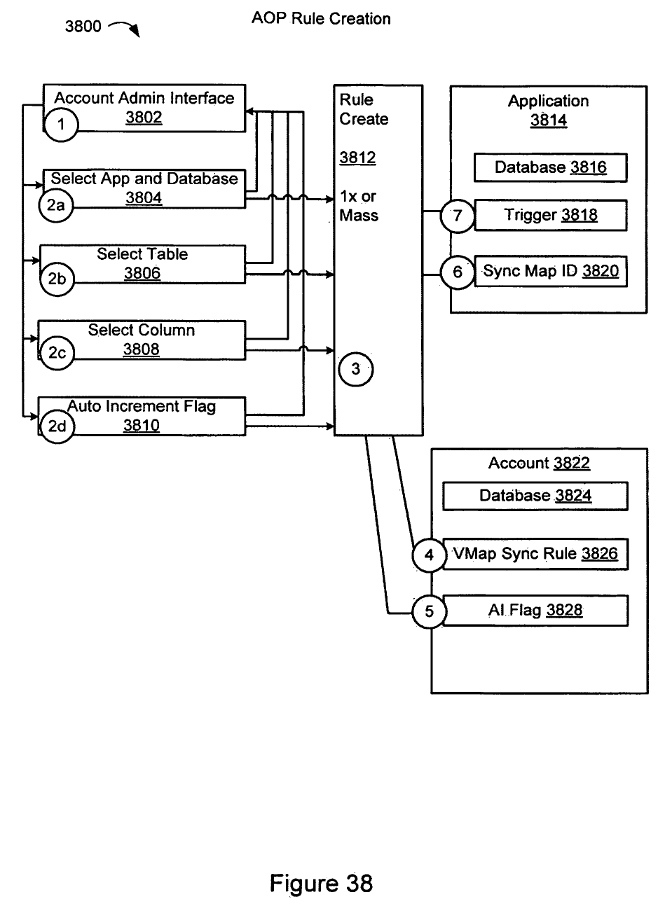

FIG. 38 presents a block diagram 3800 illustrating an exemplary process for creating synchronization rules, according to embodiments of the present invention. FIG. 38 includes one or more of account admin interface 3802, select application and database 3804, select table 3806, select column 3808, auto increment flag 3810, rule create 3812, application 3814, and/or account 3822. Application 3814 include one or more of database 3816, trigger 3818, and/or sync map ID 3820. Account 3822 includes one or more of database 3824, vmap sync rule 3826, and AI flag 3828.

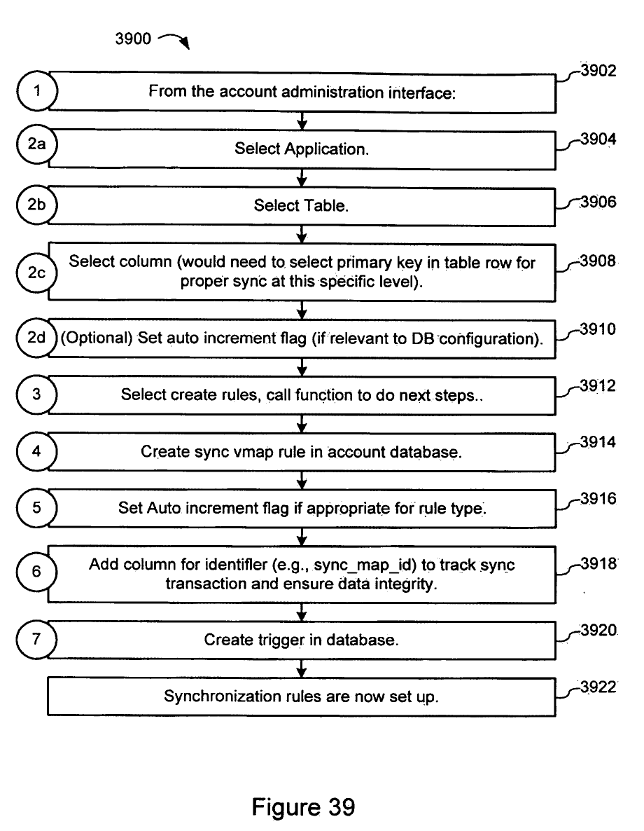

FIG. 39 presents a flowchart of an exemplary process 3900 for creating synchronization rules, according to embodiments of the present invention. FIG. 39 corresponds to the block diagram in FIG. 38. From the account admin interface (3902), a user can perform the following operations: selecting an application (which inherently selects the associated databases) (3904), selecting a table (3906), selecting a column (which can involve selecting a primary key in a table row for proper synchronization at this specific level) (3908), and/or optionally setting an auto increment flag (e.g., if relevant to the database configuration) (3910). After the user performs one or more of the previous options, the user can select a create rules function (3912), which calls functions to perform one or more of steps 3914-3922. Alternatively, the user can refine the rules by using the account admin interface to specify more rules.

After selecting the create rules function, a rules generator creates a sync vmap rule in the account database (3914). The rules generator sets an auto increment flag if appropriate for rule type (e.g., if the database table uses an auto incrementing primary key column) (3916). The rules generator adds a column for a sync_map_id, which tracks sync transactions and ensures data integrity (3918). The rules generator creates a trigger in the database (3920). The synchronization rules are now setup at step 3922. Note that a user can also select a “mass create” at one or more levels (e.g., all tables, specific tables, specific columns, etc.) in the process from now on that can automatically create sync rules for the AOP framework at every match at that level.

### Foreign Key Mapping

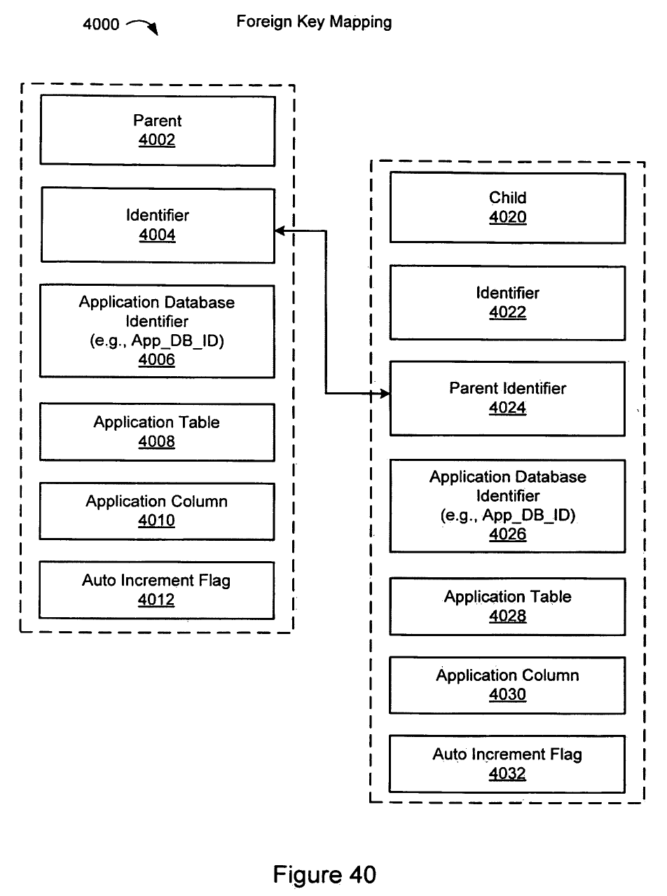

Foreign key mappings specify the relationships between a parent table and a child table. These mappings are used during the synchronization and conflict resolution processes. FIG. 40 presents a block diagram 4000 of an exemplary foreign key mapping, according to embodiments of the present invention. The foreign key mapping includes parent 4002 and child 4020. Parent 4002 includes one or more of identifier 4004, application database identifier (e.g., App_DB_ID) 4006, application table 4008, application column 4010, and auto increment flag 4012. Child 4020 includes one or more of identifier 4022, parent identifier 4024, application database identifier (e.g., App_DB_ID) 4026, application table 4028, application column 4030, and auto increment flag 4032. Parent identifier 4024 for child 4020 corresponds to identifier 4004 for parent 4002.

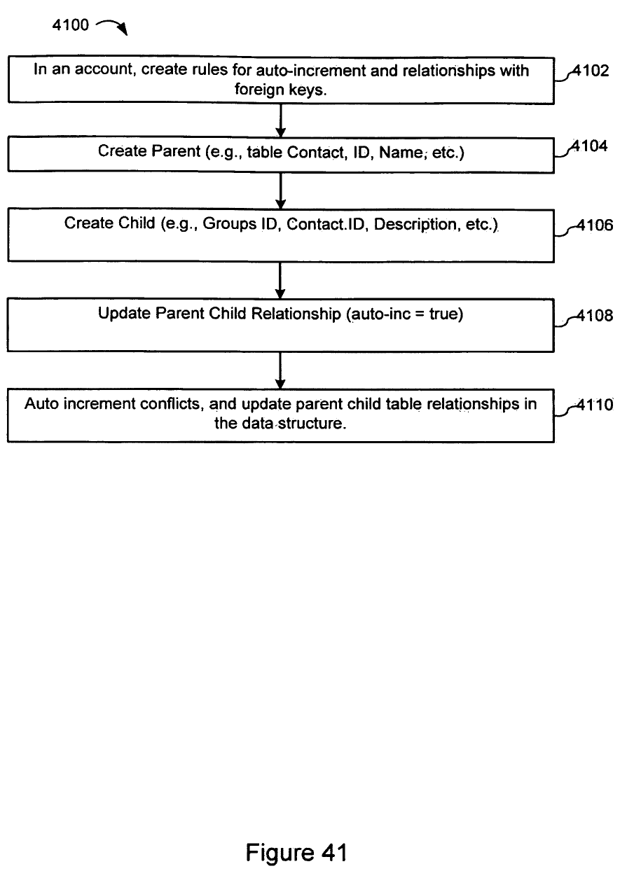

FIG. 41 presents a flowchart of an exemplary process 4100 for creating a foreign key mapping, according to embodiments of the present invention. In an account, rules for auto increment and relationships with foreign keys are created (4102). A parent is created (e.g., table Contact, ID, Name, etc.) (4104). A child is created (e.g., Groups ID, Contact.ID, Description, etc.) (4106). The parent-child relationship is updated (auto-inc=true) (4108). Auto increment any conflicts that may arise and updated parent-child table relationships in the data structure (4110).

### Summary

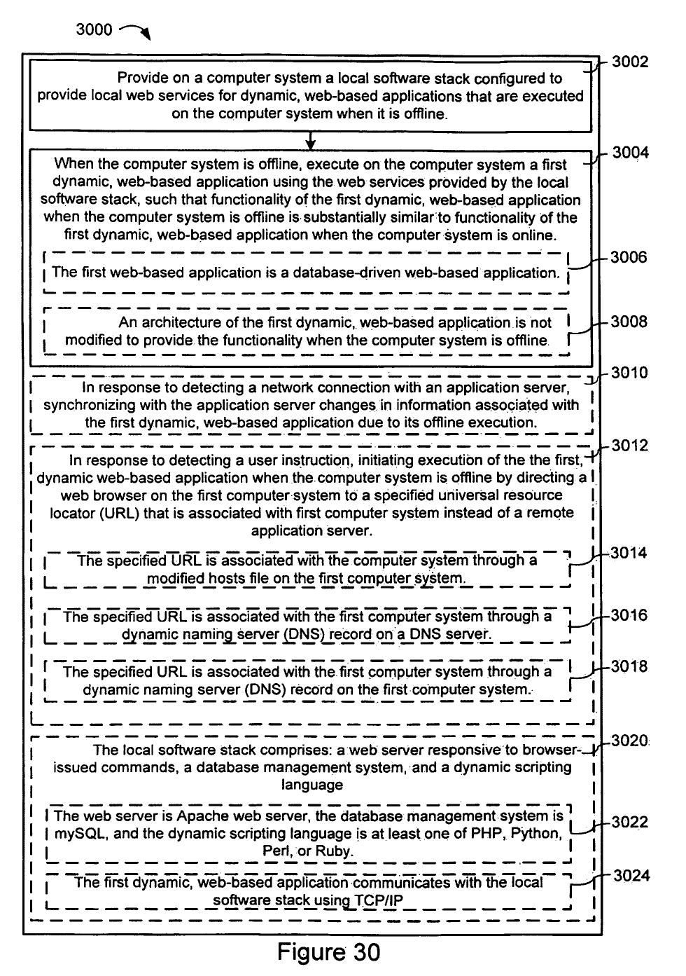

FIG. 30 presents a flowchart of an exemplary process 3000 for providing access to a web-based application while offline, according to embodiments of the present invention. The process begins by providing on a computer system a local software stack configured to provide local web services for dynamic, web-based applications that are executed on the computer system when it is offline (3002). When the computer system is offline, the computer system executes a first dynamic, web-based application using the web services provided by the local software stack, such that functionality of the first dynamic, web-based application when the computer system is offline is substantially similar to functionality of the first dynamic, web-based application when the computer system is online (3004). In some embodiments, the first web-based application is a database-driven web-based application (3006). In some embodiments, the architecture of the first dynamic, web-based application is not modified to provide the functionality when the computer system is offline (3008).

In some embodiments, in response to detecting a network connection with an application server, the computer system synchronizes with the application server changes in information associated with the first dynamic, web-based application due to its offline execution (3010).

In some embodiments, a user of the computer system initiates execution of the first, dynamic web-based application when the computer system is offline by directing a web browser on the first computer system to a specified universal resource locator (URL) that is associated with the computer system instead of a remote application server (3012). The specified URL, can be associated with the computer system through a modified hosts file on the first computer system (3014). Moreover, the specified URL can be associated with the computer system through a modified hosts file on the first computer system (3016). Furthermore, the specified URL can be associated with the first computer system through a dynamic naming server (DNS) record on the first computer system (3018).

In some embodiments, the local software stack comprises: a web server responsive to browser-issued commands, a database management system, and a dynamic scripting language (3020). In some embodiments, the web server is Apache web server, the database management system is mySQL, and the dynamic scripting language is at least one of PHP, Python, Perl, or Ruby (3022). In some embodiments, the first dynamic, web-based application communicates with the local software stack using TCP/IP (3024).

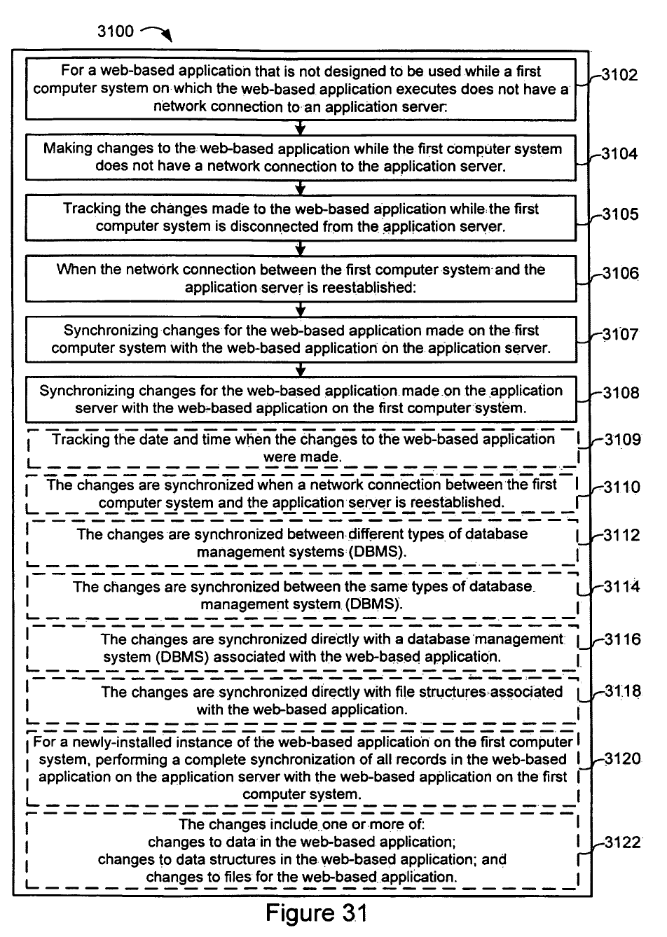

FIG. 31 presents a flowchart of an exemplary process 3100 for synchronizing a web-based application on a client computer system with a web-based application on an application server, according to embodiments of the present invention. For a web-based application that is not designed to be used while a first computer system on which the web-based application executes does not have a network connection to an application server (3102), changes are made to the web-based application while the first computer system does not have a network connection to the application server (3104). The changes made to the web-based application while the first computer system is disconnected from the application server are tracked (3105). When the network connection between the first computer system and the application server is reestablished (3106), the changes are synchronized for the web-based application made on the first computer system with the web-based application on the application server (3107). The changes are synchronized for the web-based application on the application server with the web-based application on the first computer system (3108).

In some embodiments, the date and time when the changes to the web-based application were made are tracked (3109). In some embodiments, the changes are synchronized when a network connection between the first computer system and the application server is reestablished (3110). In some embodiments, the changes are synchronized between different types of database management systems (DBMS) (3112). In some embodiments, the changes are synchronized between the same types of database management system (DBMS) (3114). In some embodiments, the changes are synchronized directly with a database management system (DBMS) associated with the web-based application (3116). In some embodiments, the changes arc synchronized directly with file structures associated with the web-based application (3118). In some embodiments, for a newly-installed instance of the web-based application on the first computer system, the method further comprises performing a complete synchronization of all records in the web-based application on the application server with the web-based application on the first computer system (3120). In some embodiments, the changes include one or more of: changes to data in the web-based application; changes to data structures in the web-based application; and/or changes to files for the web-based application (3122).

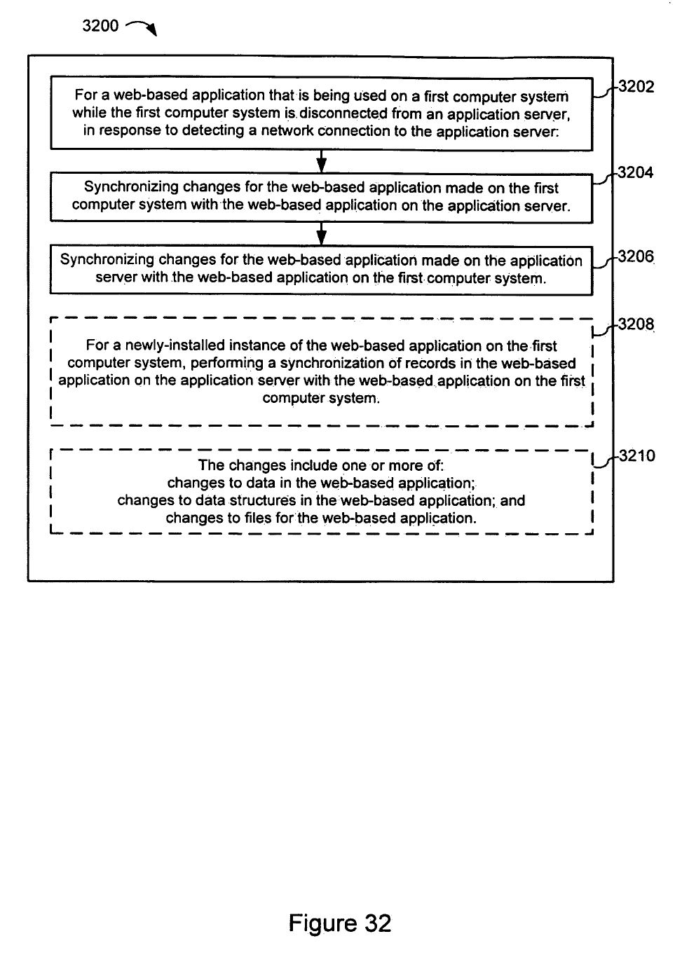

FIG. 32 presents a flowchart of an exemplary process 3200 for providing synchronizing a web-based application on a client computer system with a web-based application on an application server, according to embodiments of the present invention. For a web-based application that is being used on a first computer system while the first computer system is disconnected from an application server, in response to detecting a network connection to the application server (3202), changes made for the web-based application on the first computer system arc synchronized with the web-based application on the application server (3204). The changes made for the web-based application on the application server are also synchronized with the web-based application on the first computer system (3206).

In some embodiments, for a newly-installed instance of the web-based application on the first computer system, a synchronization of records is performed in the web-based application on the application server with the web-based application on the first computer system (3208).

In some embodiments, the changes include one or more of: changes to data in the web-based application; changes to data structures in the web-based application; and/or changes to files for the web-based application (3210).

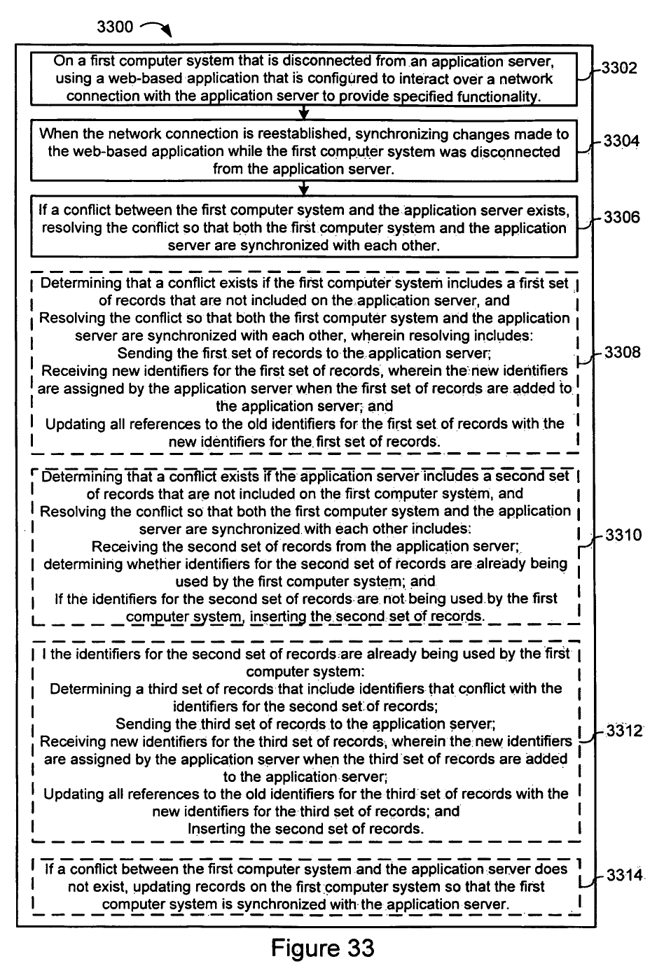

FIG. 33 presents a flowchart of an exemplary process 3300 for resolving conflicts between a web-based application on a client computer system and a web-based application on an application server, according to embodiments of the present invention. On a first computer system that is disconnected from an application server, a web-based application that is configured to interact over a network connection with the application server to provide specified functionality is used (3302). When the network connection is reestablished, changes made to the web-based application while the first computer system was disconnected from the application server are synchronized (3304). If a conflict between the first computer system and the application server exists, the conflicts are resolved so that both the first computer system and the application server are synchronized with each other (3306).

In some embodiments, a conflict exists if the first computer system includes a first set of records that are not included on the application server, and wherein resolving the conflict so that both the first computer system and the application server are synchronized with each other involves: sending the first set of records to the application server; receiving new identifiers for the first set of records, wherein the new identifiers are assigned by the application server when the first set of records are added to the application server; and updating all references to the old identifiers for the first set of records with the new identifiers for the first set of records (3308).

In some embodiments, a conflict exists if the application server includes a second set of records that are not included on the first computer system, and wherein resolving the conflict so that both the first computer system and the application server are synchronized with each other involves: receiving the second set of records from the application server; determining whether identifiers for the second set of records are already being used by the first computer system; and/or if the identifiers for the second set of records are not being used by the first computer system, inserting the second set of records (3310).

In some embodiments, if the identifiers for the second set of records are already being used by the first computer system, the following operations are performed: determining a third set of records that include identifiers that conflict with the identifiers for the second set of records; sending the third set of records to the application server; receiving new identifiers for the third set of records, wherein the new identifiers are assigned by the application server when the third set of records are added to the application server; updating all references to the old identifiers for the third set of records with the new identifiers for the third set of records; and inserting the second set of records (3312).

In some embodiments, if a conflict between the first computer system and the application server does not exist, records are updated on the first computer system so that the first computer system is synchronized with the application server (3314).

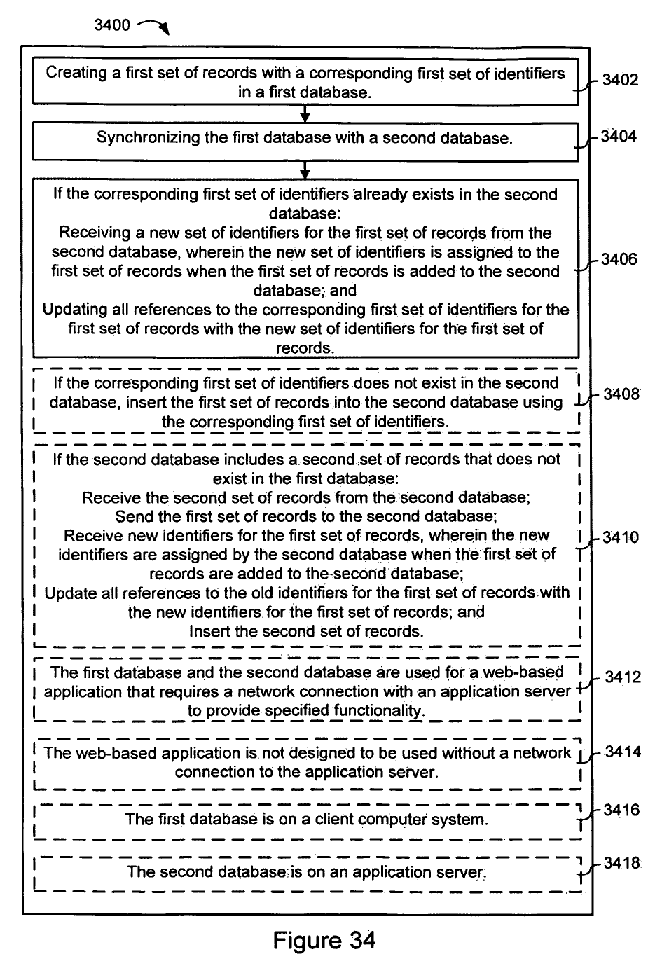

FIG. 34 presents a flowchart of an exemplary process 3400 for resolving conflicts between a web-based application on a client computer system and a web-based application on an application server that use automatically incrementing identifiers for database records, according to embodiments of the present invention. A first set of records are created with a corresponding first set of identifiers in a first database (3402). The first database is synchronized with a second database (3404). If the corresponding first set of identifiers already exists in the second database, a new set of identifiers is received for the first set of records from the second database, wherein the new set of identifiers is assigned to the first set of records when the first set of records is added to the second database, and all references to the corresponding first set of identifiers is updated for the first set of records with the new set of identifiers for the first set of records (3406).

In some embodiments, if the corresponding first set of identifiers does not exist in the second database, the first set of records is inserted into the second database using the corresponding first set of identifiers (3408).

In some embodiments, if the second database includes a second set of records that does not exist in the first database, the following operations are performed: receiving the second set of records from the second database; sending the first set of records to the second database; receiving new identifiers for the first set of records, wherein the new identifiers are assigned by the second database when the first set of records are added to the second database; updating all references to the old identifiers for the first set of records with the new identifiers for the first set of records; and inserting the second set of records (3410).

In some embodiments, the first database and the second database are used for a web-based application that requires a network connection with an application server to provide specified functionality (3412). In some embodiments, the web-based application was not designed to be used without a network connection to the application server (3414). In some embodiments, the first database is on a client computer system (3416). In some embodiments, the second database is on an application server (3418).

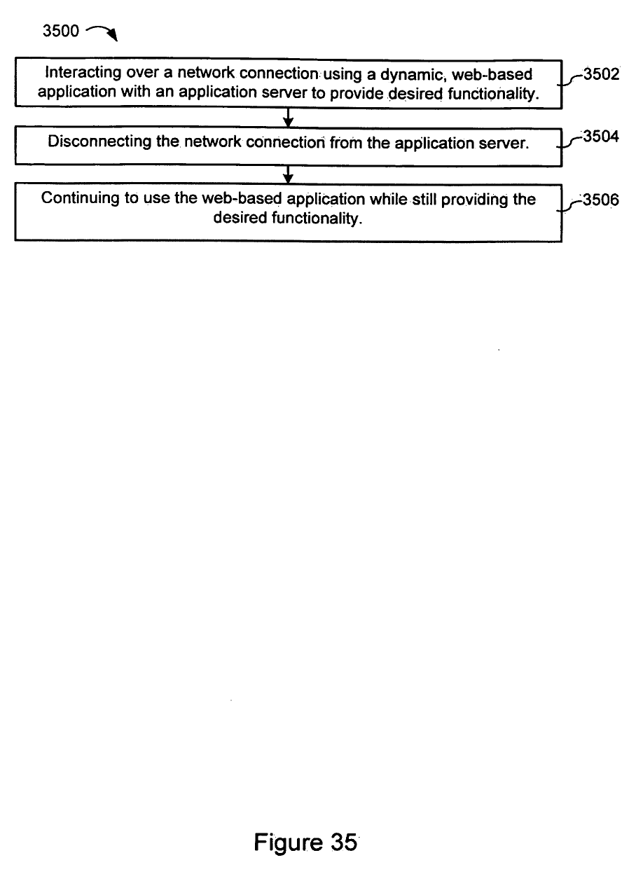

FIG. 35 presents a flowchart of an exemplary process 3500 for providing access to a web-based application while offline, according to embodiments of the present invention. A dynamic, web-based application configured to interact over a network connection with an application server to provide desired functionality is used (3502). The network connection is disconnected from the application server (3504). The web-based application continues to be used while still providing the desired functionality (3506).

In some embodiments, the dynamic, web-based application is a database-driven web-based application. In some embodiments, the architecture of the dynamic, web-based application is not modified to provide functionality when the computer system is offline. In some embodiments, in response to detecting a network connection with an application server, changes in information associated with the dynamic, web-based application due to its offline execution are synchronized with the application server. In some embodiments, a user of the computer system initiates execution of the dynamic, web-based application when the computer system is offline by directing a browser on the first computer system to a specified universal resource locator (URL) that is associated with the computer system instead of a remote application server.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
for a web-based application that is not designed to be used while a first computer system on which the web-based application executes does not have a network connection to an application server,
making changes to the web-based application while the first computer system does not have a network connection to the application server; and
tracking the changes made to the web-based application while the first computer system is disconnected from the application server;
when the network connection between the first computer system and the application server is reestablished,
synchronizing changes for the web-based application made on the first computer system with the web-based application on the application server; and
synchronizing changes for the web-based application made on the application server with the web-based application on the first computer system.

2. The method of claim 1, further comprising tracking the date and time when the changes to the web-based application were made.

3. The method of claim 1, wherein the changes are synchronized when a network connection between the first computer system and the application server is reestablished.

4. The method of claim 1 wherein the changes are synchronized between different types of database management systems (DBMS).

5. The method of claim 1 wherein the changes are synchronized between the same types of database management system (DBMS).

6. The method of claim 1, wherein the changes are synchronized directly with a database management system (DBMS) associated with the web-based application.

7. The method of claim 1, wherein the changes are synchronized directly with file structures associated with the web-based application.

8. The method of claim 1, wherein for a newly-installed instance of the web-based application on the first computer system, the method further comprises performing a complete synchronization of all records in the web-based application on the application server with the web-based application on the first computer system.

9. The method of claim 1, wherein the changes include one or more of:
changes to data in the web-based application;
changes to data structures in the web-based application; and
changes to files for the web-based application.

10. A system, comprising:
one or more processors;
memory; and
one or more programs stored in the memory, the one or more programs comprising instructions to:
for a web-based application that is not designed to be used while a first computer system on which the web-based application executes does not have a network connection to an application server,
make changes to the web-based application while the first computer system does not have a network connection to the application server; and
track the changes made to the web-based application while the first computer system is disconnected from the application server;
when the network connection between the first computer system and the application server is reestablished,
synchronize changes for the web-based application made on the first computer system with the web-based application on the application server; and
synchronize changes for the web-based application made on the application server with the web-based application on the first computer system.

11. A computer readable storage medium storing one or more programs for execution by a computer, the one or more programs comprising instructions to:
for a web-based application that is not designed to be used while a first computer system on which the web-based application executes does not have a network connection to an application server,
make changes to the web-based application while the first computer system does not have a network connection to the application server; and
track the changes made to the web-based application while the first computer system is disconnected from the application server;
when the network connection between the first computer system and the application server is reestablished,
synchronize changes for the web-based application made on the first computer system with the web-based application on the application server; and
synchronize changes for the web-based application made on the application server with the web-based application on the first computer system.

12. A method, comprising:
for a web-based application that is being used on a first computer system while the first computer system is disconnected from an application server,
in response to detecting a network connection to the application server:
synchronizing changes for the web-based application made on the first computer system with the web-based application on the application server; and
synchronizing changes for the web-based application made on the application server with the web-based application on the first computer system.

13. The method of claim 12, wherein for a newly-installed instance of the web-based application on the first computer system, the method further comprises performing a synchronization of records in the web-based application on the application server with the web-based application on the first computer system.

14. The method of claim 12, wherein the changes include one or more of:
changes to data in the web-based application;
changes to data structures in the web-based application; and
changes to files for the web-based application.

15. A system, comprising:
one or more processors;
memory; and
one or more programs stored in the memory, the one or more programs comprising instructions to:
for a web-based application that is being used on a first computer system while the first computer system is disconnected from an application server,
in response to detecting a network connection to the application server:
synchronize changes for the web-based application made on the first computer system with the web-based application on the application server; and
synchronize changes for the web-based application made on the application server with the web-based application on the first computer system.

16. A computer readable storage medium storing one or more programs for execution by a computer, the one or more programs comprising instructions to:
for a web-based application that is being used on a first computer system while the first computer system is disconnected from an application server,
in response to detecting a network connection to the application server:
synchronize changes for the web-based application made on the first computer system with the web-based application on the application server; and
synchronize changes for the web-based application made on the application server with the web-based application on the first computer system.
